(19) United States
(12) Patent Application Publication
(10) Pub. No.: US 2026/0217033 A1
(43) Pub. Date: Jul. 30, 2026

(54) LIQUID EJECTION APPARATUS AND CONTROL METHOD FOR LIQUID EJECTION APPARATUS

(71) Applicant: SEIKO EPSON CORPORATION, Tokyo (JP)

(72) Inventors: Kazuyoshi OHASHI, MATSUMOTO-SHI (JP); Shintaro KOMURO, MATSUMOTO-SHI (JP); Kohei UENO, SHIOJIRI-SHI (JP); Yusuke KOMIYAMA, MATSUMOTO-SHI (JP)

(21) Appl. No.: 19/460,709

(22) Filed: Jan. 27, 2026

(30) Foreign Application Priority Data
Jan. 28, 2025 (JP) 2025-012348

(51) Int. Cl. B41J 2/17; B41J 2/165

(52) U.S. Cl. CPC B41J 2/1721; B41J 2/16552

(57) ABSTRACT

A liquid ejection apparatus includes: a liquid ejection unit configured to eject a liquid onto a medium; a collection unit configured to collect, as a waste liquid, the liquid ejected from the liquid ejection unit; a mounting portion where a waste liquid container configured to contain the waste liquid collected by the collection unit is attachable and detachable; a waste liquid flow path configured to allow the waste liquid to flow into the waste liquid container; and a control unit configured to control the delivery of the waste liquid into the waste liquid container. The liquid ejection unit is configured to eject a recording liquid for recording on the medium, a treatment liquid that is a liquid having reactivity with the recording liquid and performs a treatment on the medium, and a cleaning liquid for cleaning the liquid ejection unit. The control unit does not discharge the treatment liquid into the waste liquid container when the recording liquid is contained in the waste liquid container, and does not discharge the recording liquid into the waste liquid container when the treatment liquid is contained in the waste liquid container.

The present application is based on, and claims priority from JP Application Serial Number 2025-012348, filed Jan. 28, 2025, the disclosure of which is hereby incorporated by reference herein in its entirety.

### BACKGROUND

### 1. Technical Field

The present disclosure relates to a liquid ejection apparatus that ejects a liquid onto a medium. The present disclosure also relates to a control method for a liquid ejection apparatus.

### 2. Related Art

An inkjet recording apparatus disclosed in JP-A-2019-188699 includes a liquid supply unit that supplies a liquid to a conveyed sheet. The liquid supplied by the liquid supply unit includes colored ink and a pre-treatment liquid that is supplied to the sheet before the colored ink is supplied.

Accordingly, the liquid supply unit includes a head portion that ejects the colored ink and a head portion that ejects the pre-treatment liquid. The pre-treatment liquid is assumed to be white ink. The head portion that ejects the pre-treatment liquid is disposed adjacent to the head portion that ejects the colored ink upstream in a sheet conveyance direction.

JP-A-2019-188699 is an example of the related art.

In general, in an inkjet recording apparatus, ink may be discharged as a waste liquid from a head portion and collected into a waste liquid tank during maintenance or the like. In such a configuration, when the ink and a treatment liquid are mixed in the waste liquid tank, there is a possibility that a problem such as liquid hardening may occur.

### SUMMARY

In order to solve the above-described problem, a liquid ejection apparatus according to the present disclosure includes: a liquid ejection unit configured to eject a liquid onto a medium; a collection unit configured to collect, as a waste liquid, the liquid ejected from the liquid ejection unit; a mounting portion where a waste liquid container configured to contain the waste liquid collected by the collection unit is attachable and detachable; a waste liquid flow path configured to allow the waste liquid to flow into the waste liquid container; and a control unit configured to control the delivery of the waste liquid into the waste liquid container, in which the liquid ejection unit is configured to eject a recording liquid for recording on the medium, a treatment liquid that is a liquid having reactivity with the recording liquid and performs a treatment on the medium, and a cleaning liquid for cleaning the liquid ejection unit, and the control unit does not discharge the treatment liquid to the waste liquid container when the recording liquid is contained in the waste liquid container, and does not discharge the recording liquid into the waste liquid container when the treatment liquid is contained in the waste liquid container.

In a control method for a liquid ejection apparatus according to the present disclosure, the liquid ejection apparatus includes a liquid ejection unit configured to eject a liquid onto a medium, a collection unit configured to collect, as a waste liquid, the liquid ejected from the liquid ejection unit, a mounting portion where a waste liquid container configured to contain the waste liquid collected by the collection unit is attachable and detachable, a waste liquid flow path configured to allow the waste liquid to flow into the waste liquid container, and a control unit configured to control the delivery of the waste liquid into the waste liquid container, the liquid ejection unit is configured to eject a recording liquid for recording on the medium, a treatment liquid that is a liquid having reactivity with the recording liquid and performs a treatment on the medium, and a cleaning liquid for cleaning the liquid ejection unit, and the control method includes: preventing the treatment liquid from being discharged into the waste liquid container when the recording liquid is contained in the waste liquid container; and preventing the recording liquid from being discharged into the waste liquid container when the treatment liquid is contained in the waste liquid container.

### BRIEF DESCRIPTION OF THE DRAWINGS

FIG. 1 shows a medium conveyance path of a liquid ejection apparatus.

FIG. 2 shows a medium conveyance path of a liquid ejection system.

FIG. 3 is a block diagram showing a control system of the liquid ejection apparatus.

FIG. 4 schematically shows a liquid flow path.

FIG. 5 is a table showing a relationship between a liquid ejection mode and a liquid cartridge mounted to a cartridge mounting portion.

FIG. 6 is a flowchart showing control related to mounting of the liquid cartridge to the mounting portion.

FIG. 7 is a flowchart showing a flow of mode setting processing.

FIG. 8 is a flowchart showing a flow of cleaning processing.

FIG. 9 is a flowchart showing a flow of cartridge determination processing.

FIG. 10 schematically shows a flow path when a plurality of waste liquid containers are used.

FIG. 11 schematically shows a configuration of a switching unit for switching a flow destination of a waste liquid from a common waste liquid flow path.

FIG. 12 shows a configuration in which a large-capacity waste liquid container can be mounted to a first mounting portion and a second mounting portion.

FIG. 13 shows another embodiment of the flow path.

FIG. 14 schematically shows a configuration of a flow path selection unit.

FIG. 15 is a table showing a relationship between the liquid ejection mode and selection by the flow path selection unit.

FIG. 16 is a flowchart showing a flow of mode determination processing.

### DESCRIPTION OF EMBODIMENTS

The present disclosure will schematically be described below.

A liquid ejection apparatus according to a first aspect includes: a liquid ejection unit configured to eject a liquid onto a medium; a collection unit configured to collect, as a waste liquid, the liquid ejected from the liquid ejection unit; a mounting portion where a waste liquid container configured to contain the waste liquid collected by the collection unit is attachable and detachable; a waste liquid flow path configured to allow the waste liquid to flow into the waste liquid container; and a control unit configured to control the delivery of the waste liquid into the waste liquid container, in which the liquid ejection unit is configured to eject a recording liquid for recording on the medium, a treatment liquid that is a liquid having reactivity with the recording liquid and performs a treatment on the medium, and a cleaning liquid for cleaning the liquid ejection unit, and the control unit does not discharge the treatment liquid into the waste liquid container when the recording liquid is contained in the waste liquid container, and does not discharge the recording liquid into the waste liquid container when the treatment liquid is contained in the waste liquid container.

According to this aspect, since the control unit does not discharge the treatment liquid into the waste liquid container when the recording liquid is contained in the waste liquid container and does not discharge the recording liquid into the waste liquid container when the treatment liquid is contained in the waste liquid container, it is possible to prevent the recording liquid and the treatment liquid from being mixed in the waste liquid container.

A second aspect is an aspect dependent on the first aspect, in which the control unit is switchable between a recording mode when recording is performed on the medium by the recording liquid, a treatment mode when a treatment is performed on the medium by the treatment liquid, and a cleaning mode when the waste liquid flow path is cleaned by the cleaning liquid, and the control unit further prompts replacement of the waste liquid container before switching from one of the recording mode and the treatment mode to the other.

According to this aspect, the recording, the treatment, and the cleaning can be appropriately performed in each mode.

In addition, since the control unit prompts the replacement of the waste liquid container when the mode is switched, it is possible to more reliably prevent the recording liquid and the treatment liquid from being mixed in the waste liquid container.

In this specification, “the control unit prompts the replacement of the waste liquid container” means that the control unit prompts a user to replace the waste liquid container. For example, when the liquid ejection apparatus includes a display unit that displays various information, the control unit can display a message prompting the replacement of the waste liquid container on the display unit. In addition, when the liquid ejection apparatus can communicate with an external apparatus and the external apparatus includes a display unit that displays various information, the control unit can display the message prompting the replacement of the waste liquid container on the display unit.

A third aspect is an aspect dependent on the second aspect, in which the control unit switches to the cleaning mode before switching from one mode of the recording mode and the treatment mode to the other mode, and switches from the one mode to the other mode when the waste liquid container is replaced after the cleaning of the waste liquid flow path is completed.

According to this aspect, it is possible to prevent the mixing of the recording liquid and the treatment liquid in the waste liquid flow path by interposing the cleaning of the waste liquid flow path before switching from one of the recording mode and the treatment mode to the other.

A fourth aspect is an aspect dependent on the first aspect, in which the control unit is configured to store, in a storage medium, the type of the waste liquid discharged into the waste liquid container mounted to the mounting portion.

According to this aspect, since the control unit can store, in the storage medium, the type of the waste liquid discharged into the waste liquid container mounted to the mounting portion, it is possible to more reliably prevent the recording liquid and the treatment liquid from being mixed in the waste liquid container.

This aspect is not limited to the first aspect described above, but may also be dependent on the second or third aspect described above.

A fifth aspect is an aspect dependent on the first aspect, in which the waste liquid container is a first waste liquid container, the mounting portion is a first mounting portion, and the waste liquid flow path is a first waste liquid flow path, the liquid ejection apparatus further includes: a second mounting portion where a second waste liquid container configured to contain the waste liquid collected by the collection unit is attachable and detachable; a second waste liquid flow path configured to allow the waste liquid to flow into the second waste liquid container; a common waste liquid flow path configured to allow the waste liquid to flow from the collection unit to the first waste liquid flow path and the second waste liquid flow path; and a switching unit configured to switch a flow destination of the waste liquid from the common waste liquid flow path to one of the first waste liquid flow path and the second waste liquid flow path, and the control unit does not discharge the treatment liquid to the second waste liquid container when the recording liquid is contained in the second waste liquid container, and does not discharge the recording liquid to the second waste liquid container when the treatment liquid is contained in the second waste liquid container.

According to this aspect, since the control unit does not discharge the treatment liquid to the second waste liquid container when the recording liquid is contained in the second waste liquid container and does not discharge the recording liquid to the second waste liquid container when the treatment liquid is contained in the second waste liquid container, it is possible to prevent the recording liquid and the treatment liquid from being mixed in the second waste liquid container.

This aspect is not limited to the first aspect described above, but may also be dependent on any one of the second to fourth aspects described above.

A sixth aspect is an aspect dependent on the fifth aspect, in which the control unit discharges the recording liquid to the first waste liquid container and discharges the treatment liquid to the second waste liquid container.

According to this aspect, since the first waste liquid container is used as a discharge destination of the recording liquid and the second waste liquid container is used as a discharge destination of the treatment liquid, it is possible to discharge the recording liquid and the treatment liquid without requiring the user to perform a special replacement operation.

A seventh aspect is an aspect dependent on the sixth aspect, in which the control unit discharges the recording liquid to the first waste liquid container when the recording liquid is contained in the first waste liquid container or when the waste liquid is not contained in the first waste liquid container, and discharges the treatment liquid to the second waste liquid container when the treatment liquid is contained in the second waste liquid container or when the waste liquid is not contained in the second waste liquid container.

According to this aspect, when the waste liquid is not contained in the first waste liquid container, the recording liquid is discharged to the first waste liquid container, and thus the first waste liquid container can be set as the discharge destination of the recording liquid. In addition, when the waste liquid is not contained in the second waste liquid container, the treatment liquid is discharged to the second waste liquid container, and thus the second waste liquid container can be set as the discharge destination of the treatment liquid.

An eighth aspect is an aspect dependent on the fifth aspect, in which the liquid ejection unit is configured to eject the treatment liquid as a first treatment liquid and is further configured to eject a second treatment liquid that is a liquid having reactivity with the recording liquid and the treatment liquid and performs a treatment on the medium, and the control unit does not discharge the second treatment liquid to either the first waste liquid container or the second waste liquid container and prompts replacement of the first waste liquid container or the second waste liquid container, when the recording liquid is contained in the first waste liquid container and the first treatment liquid is contained in the second waste liquid container, and does not discharge the recording liquid to either the first waste liquid container or the second waste liquid container and prompts the replacement of the first waste liquid container or the second waste liquid container when the first treatment liquid is contained in the first waste liquid container and the second treatment liquid is contained in the second waste liquid container.

According to this aspect, when there is no appropriate discharge destination of the waste liquid, by prompting the replacement of the first waste liquid container or the second waste liquid container, it is possible to prevent a plurality of types of the waste liquid from being mixed in the first waste liquid container or the second waste liquid container.

This aspect is not limited to the fifth aspect described above, but may also be dependent on the sixth or seventh aspect described above.

A ninth aspect is an aspect dependent on the fifth aspect, in which the control unit is switchable between a recording mode when recording is performed on the medium by the recording liquid, a treatment mode when a treatment is performed on the medium by the treatment liquid, and a cleaning mode when the first waste liquid flow path or the second waste liquid flow path is cleaned by the cleaning liquid, and the control unit further switches the switching unit before switching from one of the recording mode and the treatment mode to the other.

According to this aspect, the recording, the treatment, and the cleaning can be appropriately performed in each mode.

Since the control unit switches the switching unit when the mode is switched, it is possible to prevent a plurality of types of the waste liquid from being mixed in the first waste liquid container or the second waste liquid container.

This aspect is not limited to the fifth aspect described above, but may also be dependent on any one of the sixth to eighth aspects described above.

A tenth aspect is an aspect dependent on the fifth aspect, in which the control unit is configured to grasp an amount of the waste liquid contained in the first waste liquid container, and an amount of the waste liquid contained in the second waste liquid container, and the control unit further discharges the cleaning liquid to a waste liquid container where the amount of the contained waste liquid is smaller among the first waste liquid container and the second waste liquid container.

According to this aspect, since the control unit discharges the cleaning liquid into the waste liquid container where the amount of the contained waste liquid is smaller among the first waste liquid container and the second waste liquid container, it is possible to reduce the replacement frequency of the waste liquid container.

This aspect is not limited to the fifth aspect described above, but may also be dependent on any one of the sixth to ninth aspects described above.

An eleventh aspect is an aspect dependent on the fifth aspect, in which the control unit discharges the waste liquid of a same type to the first waste liquid container and the second waste liquid container.

According to this aspect, since the control unit discharges the waste liquid of the same type to the first waste liquid container and the second waste liquid container, it is possible to reduce the replacement frequency of the waste liquid container when the waste liquid of the same type is discharged.

This aspect is not limited to the fifth aspect described above, but may also be dependent on any one of the sixth to tenth aspects described above.

A twelfth aspect is an aspect dependent on the fifth aspect, in which a large-capacity waste liquid container mountable using spaces of both the first mounting portion and the second mounting portion is mountable to the first mounting portion and the second mounting portion, and the control unit discharges the waste liquid of a same type to the large-capacity waste liquid container.

According to this aspect, since the large-capacity waste liquid container mountable using both the first mounting portion and the second mounting portion is mountable to the first mounting portion and the second mounting portion, and the control unit discharges the waste liquid of the same type to the large-capacity waste liquid container, it is possible to reduce the replacement frequency of the waste liquid container when the waste liquid of the same type is discharged.

This aspect is not limited to the fifth aspect described above, but may also be dependent on any one of the sixth to tenth aspects described above.

In a control method for a liquid ejection apparatus according to a thirteenth aspect, the liquid ejection apparatus includes a liquid ejection unit configured to eject a liquid onto a medium, a collection unit configured to collect, as a waste liquid, the liquid ejected from the liquid ejection unit, a mounting portion where a waste liquid container configured to contain the waste liquid collected by the collection unit is attachable and detachable, a waste liquid flow path configured to allow the waste liquid to flow into the waste liquid container, and a control unit configured to control the delivery of the waste liquid into the waste liquid container, the liquid ejection unit is configured to eject a recording liquid for recording on the medium, a treatment liquid that is a liquid having reactivity with the recording liquid and performs a treatment on the medium, and a cleaning liquid for cleaning the liquid ejection unit, and the control method includes: preventing the treatment liquid from being discharged into the waste liquid container when the recording liquid is contained in the waste liquid container; and preventing the recording liquid from being discharged into the waste liquid container when the treatment liquid is contained in the waste liquid container.

According to this aspect, since the control method does not discharge the treatment liquid into the waste liquid container when the recording liquid is contained in the waste liquid container and does not discharge the recording liquid into the waste liquid container when the treatment liquid is contained in the waste liquid container, it is possible to prevent the recording liquid and the treatment liquid from being mixed in the waste liquid container.

A fourteenth aspect is an aspect dependent on the thirteenth aspect, in which the waste liquid container is a first waste liquid container, the mounting portion is a first mounting portion, and the waste liquid flow path is a first waste liquid flow path, the liquid ejection apparatus includes a second mounting portion where a second waste liquid container configured to contain the waste liquid collected by the collection unit is attachable and detachable, a second waste liquid flow path configured to allow the waste liquid to flow to the second waste liquid container, a common waste liquid flow path configured to allow the waste liquid to flow from the collection unit to the first waste liquid flow path and the second waste liquid flow path, and a switching unit configured to switch a flow destination of the waste liquid from the common waste liquid flow path to one of the first waste liquid flow path and the second waste liquid flow path, and the control method further including: preventing the treatment liquid from being discharged to the second waste liquid container when the recording liquid is contained in the second waste liquid container; and preventing the recording liquid from being discharged to the second waste liquid container when the treatment liquid is contained in the second waste liquid container.

According to this aspect, since the control method does not discharge the treatment liquid to the second waste liquid container when the recording liquid is contained in the second waste liquid container and does not discharge the recording liquid to the second waste liquid container when the treatment liquid is contained in the second waste liquid container, it is possible to prevent the recording liquid and the treatment liquid from being mixed in the second waste liquid container.

A fifteenth aspect is an aspect dependent on the fourteenth aspect, in which the waste liquid of a same type is discharged to the first waste liquid container and the second waste liquid container.

According to this aspect, since the control method discharges the waste liquid of the same type to the first waste liquid container and the second waste liquid container, it is possible to reduce the replacement frequency of the waste liquid container when the waste liquid of the same type is discharged.

Hereinafter, the present disclosure will be specifically described.

An X-Y-Z coordinate system shown in the figures is an orthogonal coordinate system in which a direction pointed by an arrow is a +direction and a direction opposite to the +direction is a −direction. A Y-axis direction is a direction intersecting a medium conveyance direction, that is, a medium width direction, and is an apparatus depth direction. In the embodiment, among side surfaces forming a periphery of an apparatus main body 2 of a liquid ejection apparatus 1, a side surface in a +Y direction is a back surface, and a side surface in a −Y direction is a front surface.

An X-axis direction is an apparatus width direction, a +X direction is a left side and a −X direction is a right side when viewed from an operator of the liquid ejection apparatus 1. In addition, the −X direction is a direction in which a medium is fed out from each media cassette to be described later. In addition, the +X direction is the medium conveyance direction at a position facing a liquid ejection unit 12.

A Z-axis direction is a vertical direction, that is, an apparatus height direction, a +Z direction is an upward direction and a −Z direction is a downward direction.

Hereinafter, a direction in which the medium is fed may be referred to as “downstream”, and an opposite direction thereof may be referred to as “upstream”. In each figure, a medium conveyance path is represented by broken lines. In the liquid ejection apparatus 1, the medium is conveyed through the medium conveyance path represented by the broken line.

### Configuration of Liquid Ejection Apparatus

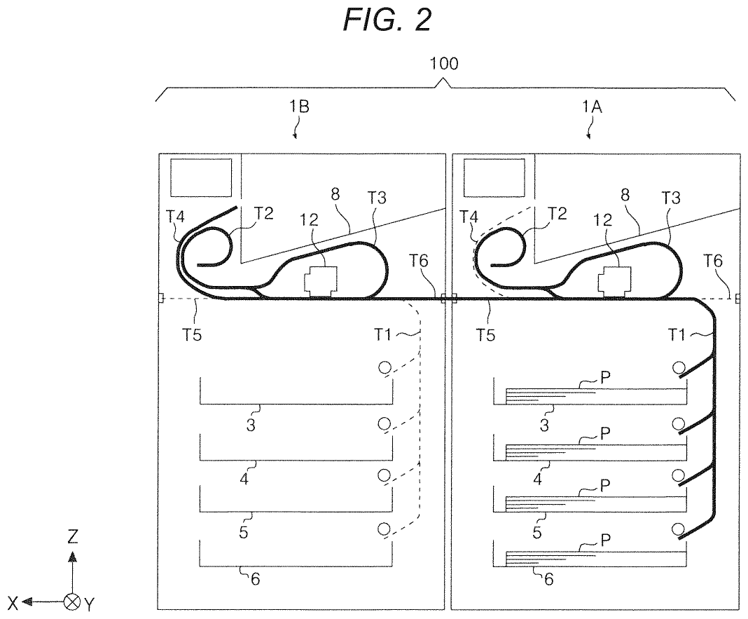

In the embodiment, the liquid ejection apparatus 1 is an inkjet printer that performs recording by ejecting ink, which is an example of a liquid, onto a medium typically represented by recording paper. A liquid ejection system 100 to be described later with reference to FIG. 2 is a system including a plurality of liquid ejection apparatuses 1.

In this specification, the terms “recording” and “printing” may be used, and both have the same meaning in that an image is formed at the medium by ejecting the liquid onto the medium. Accordingly, “recording” may be replaced with “printing” or “image formation”, and “printing” may be replaced with “recording” or “image formation”.

The liquid ejection apparatus 1 includes a plurality of media cassettes, specifically, a first media cassette 3, a second media cassette 4, a third media cassette 5, and a fourth media cassette 6 along the vertical direction at a lower portion of the apparatus main body 2 including the liquid ejection unit 12 to be described later. Hereinafter, these media cassettes are simply referred to as media cassettes when no distinction is made therebetween.

Each of the media cassettes is provided with a pick roller that feeds the contained medium out toward the −X direction. Reference signs 21, 22, 23, and 24 denote pick rollers provided to the media cassettes. A configuration for bringing the contained medium into contact with the pick roller may be a configuration in which the pick roller moves forward and backward with respect to the medium, or may be a configuration in which the medium is pushed up by a lift plate provided at each media cassette.

Each of the media cassettes is provided with a feed roller pair that further feeds downstream the medium fed out by the pick roller. Reference signs 25, 26, 27, and 28 denote the feed roller pairs provided at the media cassettes.

Hereinafter, unless particularly described otherwise, it is assumed that a “roller pair” includes a drive roller driven by a power source such as a motor and a driven roller driven to rotate in contact with the drive roller.

The medium fed out from the first media cassette 3 receives a feeding force from conveyance roller pairs 29 and 33, and is fed to a conveyance roller pair 34. The medium fed out from the second media cassette 4 receives a feeding force from conveyance roller pairs 30, 29, and 33, and is fed to the conveyance roller pair 34. The medium fed out from the third media cassette 5 receives a feeding force from conveyance roller pairs 31, 30, 29, and 33, and is fed to the conveyance roller pair 34. The medium fed out from the fourth media cassette 6 receives a feeding force from conveyance roller pairs 32, 31, 30, 29, and 33, and is fed to the conveyance roller pair 34. A reference sign T1 denotes a conveyance path of the medium that is fed out from each of the media cassettes and reaches the conveyance roller pair 34.

The medium that receives the feeding force from the conveyance roller pair 34 is fed between the liquid ejection unit 12 and a conveyance belt 66, that is, to a liquid ejection position facing the liquid ejection unit 12. The conveyance roller pair 34 constitutes a conveyance unit that conveys the medium between the liquid ejection unit 12 and the conveyance belt 66.

The liquid ejection unit 12 ejects the liquid onto a surface of the medium. In the embodiment, the liquid ejection unit 12 is a line head where a plurality of nozzles 13 that eject the liquid are disposed over an entire region in the medium width direction. However, the liquid ejection unit 12 may be an ink ejection head that is mounted to a carriage and ejects the liquid while moving in the medium width direction.

The liquid ejection unit 12 according to the embodiment adopts a piezo element that is a piezoelectric element whose volume changes when a voltage is applied. By controlling a drive waveform of the piezo element, it is possible to control movement of a meniscus of each nozzle 13 to control a size and an ejection speed of droplets to be ejected.

In the embodiment, the plurality of nozzles 13 include a nozzle that can eject yellow ink, a nozzle that can eject magenta ink, a nozzle that can eject cyan ink, and a plurality of nozzles that can eject black ink. The ink of each color is an example of a recording liquid for recording on the medium. As will be described in detail later, a cleaning liquid can be ejected from the nozzles that eject the ink of each color, and a treatment liquid represented by a pre-treatment liquid and a post-treatment liquid can be ejected.

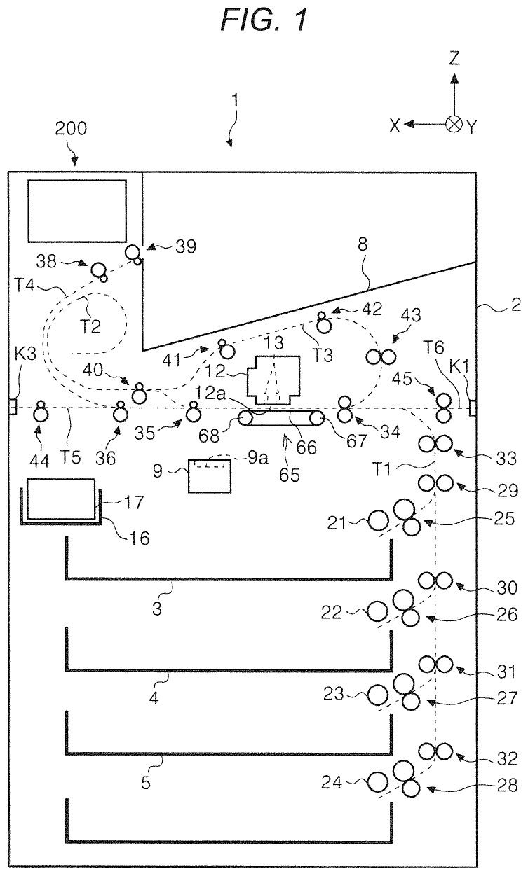

The conveyance belt 66 is an endless belt wound around a drive roller 67 and a driven roller 68, and rotates when the drive roller 67 is driven by a motor (not shown). The medium is conveyed to the position facing the liquid ejection unit 12 while being adsorbed onto a belt surface of the conveyance belt 66. The drive roller 67, the driven roller 68, and the conveyance belt 66 constitute a belt unit 65. The belt unit 65 is disposed to be pivotable by a power source (not shown) with the drive roller 67 serving as a pivoting shaft, and switches, by pivoting, between a state where the medium can be conveyed as shown in FIG. 1 and a position (not shown) retracted from the liquid ejection unit 12.

The medium onto which the liquid is ejected by the liquid ejection unit 12 is fed toward any one of a conveyance roller pair 36 and a conveyance roller pair 40 by a conveyance roller pair 35 located downstream of the conveyance belt 66. Accordingly, a path switching flap (not shown) is provided in the vicinity downstream of the conveyance roller pair 35.

When the surface of the medium is not reversed and no liquid is to be ejected again onto the medium, the medium is fed from the conveyance roller pair 35 toward the conveyance roller pair 36. A discharge path T4 and a discharge path T5 can be selected downstream of the conveyance roller pair 36. Accordingly, a path switching flap (not shown) is provided in the vicinity downstream of the conveyance roller pair 36.

When the discharge path T4 is selected, the medium is discharged to a discharge tray 8 through the discharge path T4. A conveyance roller pair 38 and a conveyance roller pair 39 are provided in the discharge path T4.

When the discharge path T5 is selected, the medium is discharged toward the +X direction from a discharge portion K3 of the apparatus main body 2 through the discharge path T5. A conveyance roller pair 44 is provided in the discharge path T5.

When the surface of the medium is reversed and the liquid is ejected onto the medium again, the medium is fed from the conveyance roller pair 35 toward the conveyance roller pair 40 to enter a switchback path T2. Thereafter, a rotation direction of the conveyance roller pair 40 is switched, the medium is switched back to enter a reverse path T3, and is fed to the conveyance roller pair 34 by conveyance roller pairs 41, 42, and 43.

The liquid ejection apparatus 1 includes a receiving portion K1 that receives the medium on a side surface in the −X direction. The receiving portion K1 is provided at a height position corresponding to a position between the liquid ejection unit 12 and the belt unit 65 in the apparatus height direction. In addition, in the embodiment, height positions of the receiving portion K1 and the discharge portion K3 are substantially the same.

The medium received from the receiving portion K1 is fed to the conveyance roller pair 34 by a conveyance roller pair 45. A reference sign T6 denotes a conveyance path through which the medium received from the receiving portion K1 is conveyed. The receiving portion K1 may also serve as a feeding port when feeding the medium placed at a placement portion (not shown) provided at the side surface in the −X direction.

A reference sign 200 denotes a cartridge mounting portion where a liquid container (to be described later) containing the liquid to be ejected from the liquid ejection unit 12 is mounted. The liquid to be ejected from the liquid ejection unit 12 is supplied from the cartridge mounting portion 200 to the liquid ejection unit 12 via a flow path to be described later.

A reference sign 9 denotes a cap unit including a cap 9a that caps the liquid ejection unit 12. The cap 9a is an example of a collection unit that collects ink ejected from the liquid ejection unit 12 as a waste liquid. The cap unit 9 is displaceable, by a power source (not shown) controlled by a control unit 80 to be described later, between a separation position (see FIG. 1) where the cap 9a is separated from the liquid ejection unit 12 and a cap position (not shown) where the cap 9a caps a head surface 12a of the liquid ejection unit 12.

By being configured as described above, the liquid ejection apparatus 1 can be coupled as shown in FIG. 2 as an example to form a system. The liquid ejection system 100 shown in FIG. 2 includes a first liquid ejection apparatus 1A and a second liquid ejection apparatus 1B. Each of the first liquid ejection apparatus 1A and the second liquid ejection apparatus 1B is the liquid ejection apparatus 1 described with reference to FIG. 1. In FIG. 2, the number of rollers and reference signs to be shown are reduced as compared to those in FIG. 1 in order to avoid complicating the figure.

The first liquid ejection apparatus 1A and the second liquid ejection apparatus 1B are mechanically coupled with a coupling portion (not shown) and are electrically coupled with a connector (not shown). Accordingly, the first liquid ejection apparatus 1A and the second liquid ejection apparatus 1B can communicate with each other, and the first liquid ejection apparatus 1A and the second liquid ejection apparatus 1B can eject the liquid onto the medium in cooperation with each other.

In the liquid ejection system 100, the medium is fed to the second liquid ejection apparatus 1B after the liquid is ejected by the first liquid ejection apparatus 1A, and the liquid is ejected by the second liquid ejection apparatus 1B. As an example, the first liquid ejection apparatus 1A ejects the pre-treatment liquid to be described later onto the medium, and the second liquid ejection apparatus 1B ejects ink onto the medium. However, the configuration is not limited thereto, and the first liquid ejection apparatus 1A may eject the ink onto the medium, and the second liquid ejection apparatus 1B may eject the post-treatment liquid onto the medium. Alternatively, both the first liquid ejection apparatus 1A and the second liquid ejection apparatus 1B may eject the ink onto the medium. Alternatively, both the first liquid ejection apparatus 1A and the second liquid ejection apparatus 1B may eject the treatment liquid onto the medium.

In FIG. 2, a thick solid line represents a medium conveyance path when the liquid is ejected in this way. The medium indicated by reference sign P is fed out from any one of media cassettes of the first liquid ejection apparatus 1A, and after the liquid is ejected onto a first surface, the medium is reversed, and the liquid is ejected onto a second surface. Then, the medium is fed to the second liquid ejection apparatus 1B, reversed after the liquid is ejected onto the second surface, the liquid is ejected onto the first surface, and then the medium is discharged to the discharge tray 8.

However, a discharge destination of the medium is not limited thereto, and the medium may be discharged from the discharge portion K3 through the discharge path T5. In this case, the medium may be discharged to a discharge tray (not shown) attached to a side surface in the +X direction of the second liquid ejection apparatus 1B. The discharge tray (not shown) may be attachable to and detachable from the second liquid ejection apparatus 1B. In addition, the medium discharged from the discharge portion K3 may be handed over to a treatment apparatus (not shown) disposed in the +X direction of the second liquid ejection apparatus 1B, a relay conveyance apparatus (not shown) that relays the medium to the treatment apparatus, or the like. The treatment apparatus may perform, for example, stapling, punching, saddle stitching, folding, or drying.

According to such a liquid ejection system 100, the ejection of the ink and the ejection of the treatment liquid onto the medium can be executed by one liquid ejection apparatus 1. Accordingly, a dedicated liquid ejection apparatus that ejects the treatment liquid is not required, the number of usage patterns of the two liquid ejection apparatuses increases, and user usability is improved.

The liquid ejection system 100 couples two liquid ejection apparatuses, and alternatively may couple three or more liquid ejection apparatuses. For example, when three liquid ejection apparatuses are coupled, the liquid can be ejected in order of a pre-treatment, recording, and a post-treatment.

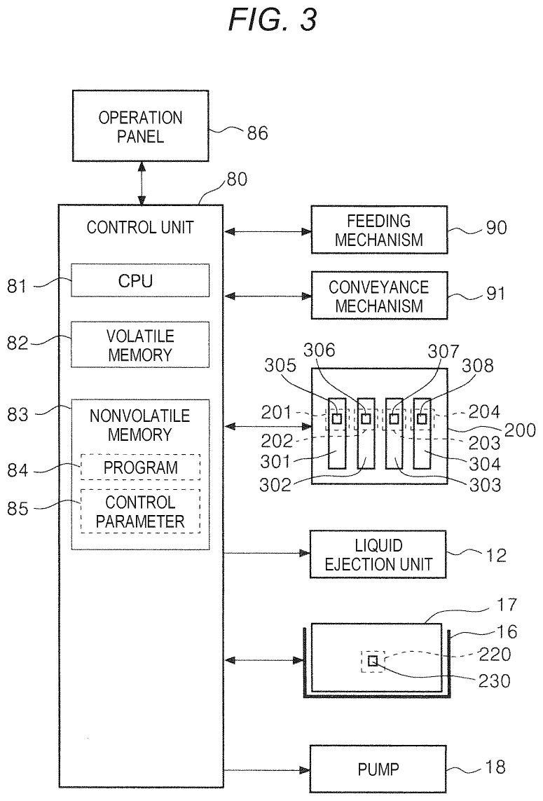

Hereinafter, the control unit 80 will be described with reference to FIG. 3.

The control unit 80 performs various types of control in the liquid ejection apparatus 1. In FIG. 3, configurations required for the following description are mainly shown, and other configurations are not shown.

The control unit 80 controls a feeding mechanism 90, a conveyance mechanism 91, the liquid ejection unit 12, a pump 18, and the cartridge mounting portion 200.

The feeding mechanism 90 includes the pick rollers 21, 22, 23, and 24, the feed roller pairs 25, 26, 27, and 28 described above, and a motor (not shown) that drives these rollers.

The conveyance mechanism 91 includes the conveyance roller pairs 29 to 45 described above, a motor (not shown) that drives these rollers, the plurality of path switching flaps that switch the feeding destination of the medium described above, and a drive source (not shown) such as a solenoid that drives the path switching flaps.

The motor (not shown) constituting the feeding mechanism 90 and the motor (not shown) constituting the conveyance mechanism 91 are, as an example, DC motors. In addition, each of the motors is provided with a rotary encoder (not shown), and the control unit 80 can detect a rotation direction, a rotation amount, and a rotation speed of each of the motors using the rotary encoder. That is, the control unit 80 can detect a drive direction, a drive amount, and a drive speed of each of the rollers.

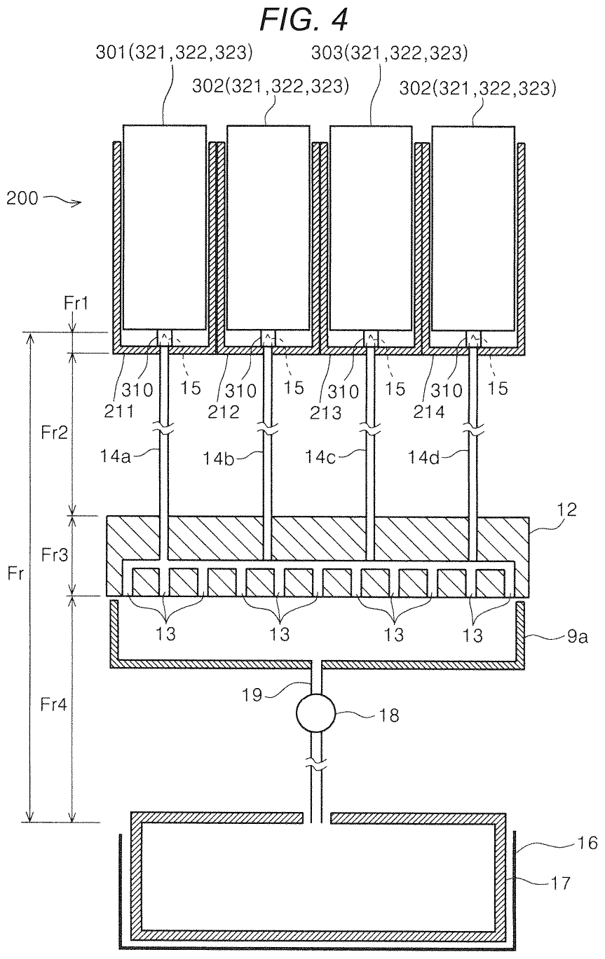

The liquid container containing the liquid to be ejected from the liquid ejection unit 12 can be mounted to the cartridge mounting portion 200. The mounting of the liquid container to the cartridge mounting portion 200 will be described in detail later, and types of the liquid include at least a recording liquid for recording on the medium and a treatment liquid for performing a treatment on the medium. The types of the liquid further include a cleaning liquid for cleaning a flow path Fr (see FIG. 4) through which the liquid contained in the liquid container flows from the liquid ejection unit 12 to a waste liquid container 17 to be described later.

Ink containing a colorant is an example of the recording liquid. Examples of the treatment liquid include a pre-treatment liquid and a post-treatment liquid. The liquid container containing the ink is hereinafter referred to as an “ink cartridge” in the embodiment. The liquid container containing the treatment liquid is referred to as a “treatment liquid cartridge” in the embodiment. The treatment liquid cartridge may be a “pre-treatment liquid cartridge” containing the pre-treatment liquid or a “post-treatment liquid cartridge” containing the post-treatment liquid. The liquid container containing the cleaning liquid is referred to as a “cleaning liquid cartridge” in the embodiment. The cartridges may be simply referred to as “cartridges” when no distinction is made therebetween. The term “liquid container” may be used instead of the term “cartridge”.

The ink cartridge is an example of a recording liquid container containing the recording liquid. The treatment liquid cartridge is an example of a treatment liquid container containing the treatment liquid for performing the treatment on the medium. The cleaning liquid cartridge is an example of a cleaning liquid container containing the cleaning liquid for cleaning the flow path Fr (see FIG. 4).

Here, the flow path Fr will be described with reference to FIG. 4. FIG. 4 schematically shows the flow path of the liquid, and the flow path Fr includes flow paths Fr1, Fr2, Fr3, and Fr4. Fr1 is a section in the cartridge mounting portion 200. The flow path Fr2 is a section formed of tubes 14a, 14b, 14c, and 14d that couple the cartridge mounting portion 200 and the liquid ejection unit 12. The flow path Fr3 is a section in the liquid ejection unit 12 including the nozzle 13. Fr4 is a section from the cap 9a into the waste liquid container 17. The flow path Fr4 is an example of a waste liquid flow path. Hereinafter, the tubes 14a, 14b, 14c, and 14d are collectively referred to as tubes 14 when no distinction is made therebetween.

The flow path Fr can be cleaned by discharging the cleaning liquid from the nozzle 13 and operating the pump 18 in a state where the cleaning liquid cartridge is mounted to the cartridge mounting portion 200.

The cartridge mounting portion 200 according to the embodiment includes a first mounting portion 211, a second mounting portion 212, a third mounting portion 213, and a fourth mounting portion 214 for mounting the cartridge. That is, a plurality of cartridges are attachable to and detachable from the cartridge mounting portion 200 according to the embodiment.

A liquid supply needle 15 is provided at a bottom portion of each of the containers. The liquid supply needle 15 is provided at one end side of the tube 14. Each cartridge is provided with a liquid supply unit 310, and when each cartridge is mounted to each cartridge container, the liquid supply needle 15 enters the liquid supply unit 310, and it becomes possible to supply the liquid from the cartridge.

One end of the tube 19 is coupled to the cap 9a that caps the liquid ejection unit 12. The other end of the tube 19 enters the waste liquid container 17, and accordingly, the liquid ejected to the cap 9a is collected by the waste liquid container 17 as a waste liquid. Reference sign 18 denotes a pump that generates a negative pressure in the cap 9a. When the pump 18 operates in a state where the cap 9a caps the liquid ejection unit 12, the liquid is suctioned from the nozzle 13 and fed into the waste liquid container 17. Alternatively, even when the cap 9a is separated from the liquid ejection unit 12, the liquid accumulated in the cap 9a is fed into the waste liquid container 17 by operating the pump 18. The control unit 80 controls the delivery of the waste liquid into the waste liquid container 17.

The waste liquid container 17 is attachable to and detachable from the mounting portion 16.

The waste liquid stored in the waste liquid container 17 is not limited to the waste liquid collected by the cap 9a, and may be, for example when a configuration is provided in which the ink is discarded to a platen (not shown) for borderless printing, the waste liquid discarded to the platen.

As described above, in the liquid ejection apparatus 1, since the flow path Fr can be cleaned, by cleaning the flow path Fr, it is possible to prevent different types of liquids from being mixed, and thus it is possible to obtain a favorable result.

In the embodiment, since it is possible to mount the cleaning liquid cartridge containing the cleaning liquid for cleaning the flow path Fr to the cartridge mounting portion 200, the flow path Fr can easily be cleaned. By cleaning the flow path Fr, it is possible to prevent the different types of liquids from being mixed, and thus it is possible to obtain a favorable result.

In FIGS. 3 and 4, ink cartridges are mounted as an example. Specifically, an ink cartridge 301 containing black ink is mounted to the first mounting portion 211. An ink cartridge 302 containing magenta ink is mounted to the second mounting portion 212. An ink cartridge 303 containing cyan ink is mounted to the third mounting portion 213. An ink cartridge 304 containing yellow ink is mounted to the fourth mounting portion 214.

Hereinafter, the ink cartridges may be described without using reference signs. Specifically, the black ink cartridge 301 may be referred to as an “ink cartridge (BK)”, the magenta ink cartridge 302 may be referred to as an “ink cartridge (M)”, the cyan ink cartridge 303 may be referred to as an “ink cartridge (C)”, and the yellow ink cartridge 304 may be referred to as an “ink cartridge (Y)”.

In FIG. 4, reference sign 321 denotes a pre-treatment liquid cartridge, reference sign 322 denotes a post-treatment liquid cartridge, and reference sign 323 denotes a cleaning liquid cartridge.

Instead of the ink cartridges, the pre-treatment liquid cartridge 321, the post-treatment liquid cartridge 322, and the cleaning liquid cartridge 323 can be mounted to each container.

Hereinafter, the pre-treatment liquid cartridge 321, the post-treatment liquid cartridge 322, and the cleaning liquid cartridge 323 may be referred to only by names without reference signs.

As shown in FIG. 3, the liquid container, that is, each cartridge, is provided with a cartridge IC as an example of an information storage unit that stores information such as a type and a remaining amount of the liquid. Reference sign 305 denotes the cartridge IC provided at the black ink cartridge 301, and reference sign 306 denotes the cartridge IC provided at the magenta ink cartridge 302. Reference sign 307 denotes the cartridge IC provided at the cyan ink cartridge 303, and reference sign 308 denotes the cartridge IC provided at the yellow ink cartridge 304. The cartridge IC of each ink cartridge stores information such as the fact that the liquid is the ink, an ink color, and a remaining amount.

The cartridge IC is also provided at the treatment liquid cartridge and the cleaning liquid cartridge to be described later. Hereinafter, the cartridge ICs provided at the respective cartridges may be simply referred to as the cartridge IC without distinction.

The cartridge mounting portion 200 is provided with a contact that can electrically contact the cartridge IC. Reference sign 201 denotes a contact provided at the first mounting portion 211, reference sign 202 denotes a contact provided at the second mounting portion 212, reference sign 203 denotes a contact provided at the third mounting portion 213, and reference sign 204 denotes a contact provided at the fourth mounting portion 214.

The control unit 80 can detect the information such as the type and the remaining amount of the liquid by reading the information from the cartridge IC. When the liquid is consumed, the control unit 80 updates the remaining amount information in the cartridge IC based on a consumption amount thereof. The control unit 80 can also detect that the cartridge has been replaced by reading the information from the cartridge IC at a predetermined timing or at predetermined intervals.

The waste liquid container 17 is provided with a waste liquid container IC 230, which is an example of an information storage unit that stores information on the waste liquid container 17. The mounting portion 16 where the waste liquid container 17 is mounted is provided with a contact that can electrically contact the waste liquid container IC 230. Reference sign 220 denotes a contact provided at the mounting portion 16 for mounting the waste liquid container 17.

The control unit 80 can acquire the information on the waste liquid container 17 by reading the information from the waste liquid container IC 230. The control unit 80 can also write the information on the waste liquid container 17 into the waste liquid container IC 230. By reading the information from the waste liquid container IC 230 at a predetermined timing or at predetermined intervals, the control unit 80 can also detect that the waste liquid container 17 has been replaced.

Examples of the information on the waste liquid container 17 include at least one of individual identification information of the waste liquid container 17, whether the waste liquid is contained, the type of the contained waste liquid, and an amount of the contained waste liquid.

The information on the waste liquid container 17 may be stored in a nonvolatile memory 83 of the control unit 80 in association with, for example, the individual identification information of the waste liquid container 17.

The control unit 80 includes a CPU 81 that executes a computer program, in other words, software, a volatile memory 82, and the nonvolatile memory 83. The CPU 81 performs various calculations required for executing a program 84 stored in the nonvolatile memory 83. The volatile memory 82 is used as a temporary data storage region. The nonvolatile memory 83 stores the program 84 and a control parameter 85 required for executing the program 84. The program 84 includes a program for executing various types of processing to be described later, and the control parameter 85 includes a parameter for executing the program 84. The various types of processing to be described later are implemented by the control unit 80 executing the program 84.

In addition, the control unit 80 can receive, from an operation panel 86 provided in the liquid ejection apparatus 1, various operation settings from the user. The operation panel 86 includes a touch panel, a power button, and other setting buttons, which are not shown.

### Treatment Liquid and Cleaning Liquid

Hereinafter, the treatment liquid and the cleaning liquid will be described.

At least the ink cartridge and the treatment liquid cartridge can be selectively mounted to the cartridge mounting portion 200 of the liquid ejection apparatus 1. Furthermore, the cleaning liquid cartridge may be mountable. Therefore, the ink cartridge, the treatment liquid cartridge, and the cleaning liquid cartridge have basically the same housing shape and size.

For example, when the ink cartridge is mounted to the cartridge mounting portion 200, the liquid ejection apparatus 1 can perform recording by ejecting the ink onto the medium. In addition, for example, when the treatment liquid cartridge is mounted to the cartridge mounting portion 200, the liquid ejection apparatus 1 can perform a pre-treatment or a post-treatment on the medium according to the type of the treatment liquid. In addition, for example, when the cleaning liquid cartridge is mounted to the cartridge mounting portion 200, the liquid ejection apparatus 1 can clean the flow path Fr.

As will be described in detail later, when a plurality of cartridges are mountable to the cartridge mounting portion 200, the ink and cleaning liquid cartridges may be mixed, or the treatment liquid and cleaning liquid cartridges may be mixed. However, it is preferable to exclude a case where the ink and treatment liquid cartridges are mixed.

As the pre-treatment liquid, a pre-treatment liquid in the related art known as a liquid that is ejected onto the medium before ink ejection to prevent ink bleeding and improve recording quality can be appropriately adopted, and as an example, a pre-treatment liquid that uses pure water as a solvent and contains a coagulant such as a polyvalent metal salt can be adopted. It should be noted that, such a pre-treatment liquid is an example and is not limited thereto.

The coagulant reacts with the colorant contained in the ink, and components such as a pigment dispersion and a resin that may be contained in the ink, thereby causing the colorant to aggregate. The coagulant also reacts with a pigment dispersion and/or a resin that may be contained in an ink composition, thereby increasing a viscosity of the ink composition. Accordingly, since an ejection failure is caused when the pre-treatment liquid and the ink are mixed in the liquid flow path Fr, it is required to interpose cleaning processing when replacing the ink cartridge with the treatment liquid cartridge or when replacing the treatment liquid cartridge with the ink cartridge. It should be noted that, even when the pre-treatment liquid does not contain the coagulant, for example, when white ink is used as the pre-treatment liquid, since a desired treatment result cannot be obtained when mixing with the ink of another color, it is required to interpose the cleaning processing when replacing the ink cartridge with the treatment liquid cartridge or when replacing the treatment liquid cartridge with the ink cartridge.

As the post-treatment liquid, it is possible to appropriately adopt a post-treatment liquid in the related art known as a post-treatment liquid that is ejected onto the medium where the ink has been ejected to cover a recorded surface thereof with a protective layer formed of a coating film and thus improve water resistance, light resistance, gas resistance, abrasion resistance, glossiness, color development, and the like of a recorded image. Examples of the post-treatment liquid include, but are not limited to, a post-treatment liquid containing a water-soluble resin or a water-soluble emulsion using pure water as a solvent. Since the post-treatment liquid may also be mixed with the ink to cause, for example, an increase in a viscosity of the ink, it is still required to interpose the cleaning processing when replacing the ink cartridge with the treatment liquid cartridge or when replacing the treatment liquid cartridge with the ink cartridge.

The cleaning liquid may be any cleaning liquid as long as the nozzles 13 and the flow path Fr can be cleaned, and as an example, a liquid that contains pure water as a main component and contains a surfactant, a viscosity modifier, and a defoaming agent can be adopted. It should be noted that, such a cleaning liquid is an example and is not limited thereto.

### Control Related to Mounting of Liquid Container

Next, in control by the control unit 80 of the liquid ejection apparatus 1, particularly, control related to mounting of the liquid container, that is, the cartridge to the cartridge mounting portion 200 will be described.

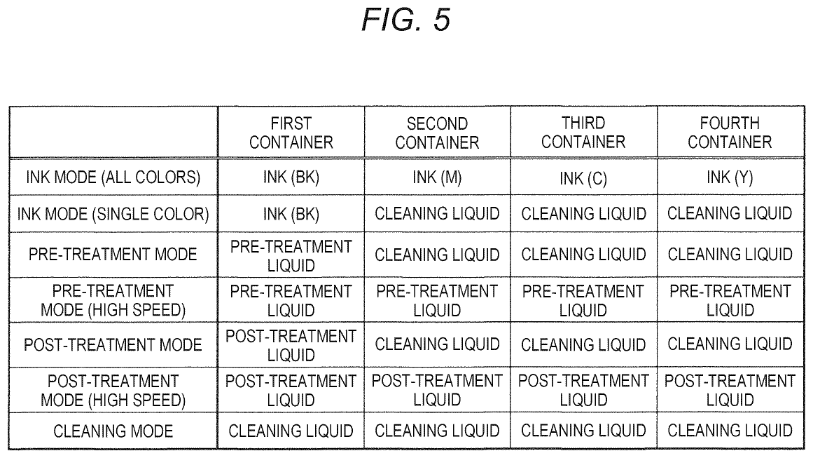

First, liquid ejection modes of the liquid ejection apparatus 1 will be described with reference to FIG. 5. The liquid ejection apparatus 1 according to the embodiment can execute any one of liquid ejection modes shown in FIG. 5 according to the type of the cartridge mounted to the cartridge mounting portion 200. In FIG. 5, notation “ink” means the ink cartridge, notation “pre-treatment liquid” means the pre-treatment liquid cartridge, notation “post-treatment liquid” means the post-treatment liquid cartridge, and notation “cleaning liquid” means the cleaning liquid cartridge.

In this specification, when simply referred to as the liquid ejection mode, the mode means a state of the liquid ejection apparatus 1 according to the type of the cartridge mounted to the cartridge mounting portion 200. Execution of the liquid ejection mode means that processing corresponding to the liquid ejection mode is actually performed. For example, execution of an ink mode means ink ejection onto the medium, execution of a treatment mode means treatment liquid ejection onto the medium, and execution of a cleaning mode means cleaning the flow path Fr.

In the embodiment, any one of the ink cartridge (BK), the pre-treatment liquid cartridge, the post-treatment liquid cartridge, and the cleaning liquid cartridge can be mounted to the first mounting portion 211.

Any one of the ink cartridge (M), the pre-treatment liquid cartridge, the post-treatment liquid cartridge, and the cleaning liquid cartridge can be mounted to the second mounting portion 212.

Any one of the ink cartridge (C), the pre-treatment liquid cartridge, the post-treatment liquid cartridge, and the cleaning liquid cartridge can be mounted to the third mounting portion 213.

Any one of the ink cartridge (Y), the pre-treatment liquid cartridge, the post-treatment liquid cartridge, and the cleaning liquid cartridge can be mounted to the fourth mounting portion 214.

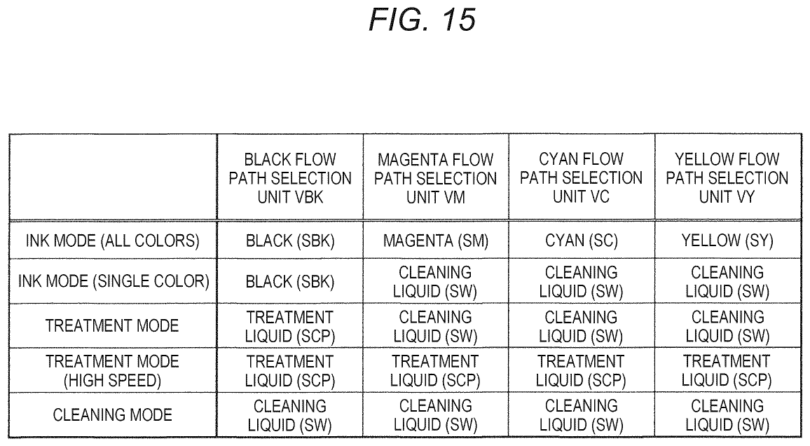

A relationship between the type of the cartridge mounted to each mounting portion and the liquid ejection mode is as shown in FIG. 15. In the embodiment, the liquid ejection apparatus 1 can execute any one of an ink mode (all colors), an ink mode (single color), a pre-treatment mode, a pre-treatment mode (high speed), a post-treatment mode, a post-treatment mode (high speed), and a cleaning mode. It is not necessarily required that all of these modes be executed. A mode other than the above may also be provided.

The ink mode (all colors) and the ink mode (single color) are examples of a recording mode when recording is performed on the medium with ink, which is an example of the recording liquid. In addition, the pre-treatment mode, the pre-treatment mode (high speed), the post-treatment mode, and the post-treatment mode (high speed) are examples of a treatment mode when a treatment is performed on the medium with the treatment liquid. The cleaning mode is a mode when the flow path Fr is cleaned with the cleaning liquid.

A control method for the liquid ejection apparatus 1 implemented by the control unit 80 includes executing each mode described above.

The recording, the treatment, and the cleaning can be appropriately performed depending on each mode described above.

It is required to mount a certain cartridge at each container. This is because, when the cartridges are not mounted to all the containers, for example, when a negative pressure is generated in the cap 9a to suction the liquid from the nozzle 13, the negative pressure is not appropriately formed, and the suction may not be possible.

Accordingly, for example, in the ink mode (single color), the pre-treatment mode, and the post-treatment mode, a required cartridge is mounted to the first mounting portion 211, and cleaning liquid cartridges are mounted to other containers. In addition to the ink mode (single color), a mode may be provided in which an ink cartridge is mounted to a container of any color and cleaning liquid cartridges are mounted to other containers. According to such a mounting manner, it is possible to reduce a liquid consumption cost as compared to a case where only the cartridge at the first mounting portion 211 is used while mounting ink cartridges or treatment liquid cartridges at containers other than the first mounting portion 211. This is because the cleaning liquid is less expensive in most cases than the ink and the treatment liquid, and even when the liquid is ejected using only the cartridge at the first mounting portion 211, liquids of cartridges of the other containers are also consumed during maintenance of the liquid ejection unit 12. Accordingly, with these modes, it is possible to customize the liquid ejection apparatus 1 according to a print result desired by the user while reducing the cost.

Next, processing performed by the control unit 80 will be described.

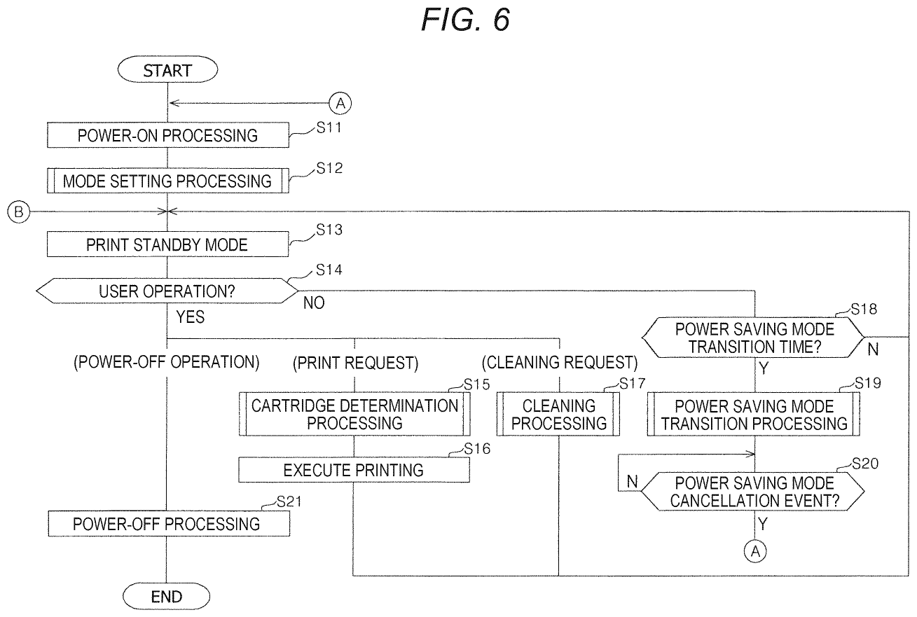

FIG. 6 is a main flow of control related to mounting of the liquid container, that is, the cartridge to the cartridge mounting portion 200.

When power of the apparatus is turned on, the control unit 80 performs power-on processing (step S11). Here, the power-on of the apparatus includes not only a case where a power button (not shown) provided on the operation panel 86 is pressed but also a case of returning from a power saving mode. The power-on processing here is initialization processing of a general printer, and includes, for example, a home detection or reset operation for a movable part.

Next, the control unit 80 performs mode setting processing (step S12). The mode here is the liquid ejection mode described with reference to FIG. 5. In the mode setting processing, it is checked whether the cartridge mounted to the cartridge mounting portion 200 matches the liquid ejection mode grasped by the control unit 80, and required predetermined processing is performed when the cartridge does not match. That is, in a power-off state, since there is a possibility that the cartridge mounted to the cartridge mounting portion 200 is replaced by the user, such checking is performed in the mode setting processing.

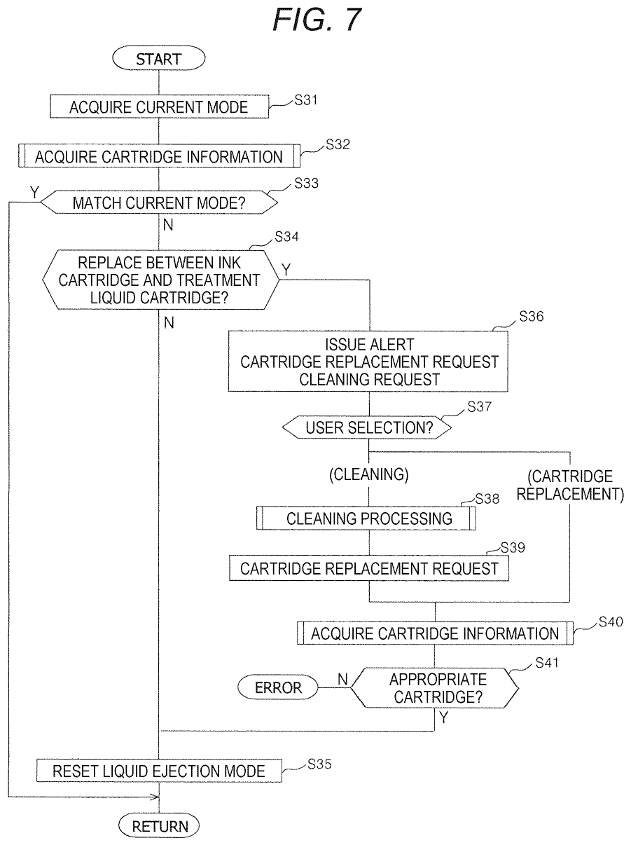

Hereinafter, the mode setting processing will be described with reference to FIG. 7.

The control unit 80 acquires a current mode (step S31). The current mode is stored in the nonvolatile memory 83 (see FIG. 3). Next, the control unit 80 acquires, from the cartridge IC, the information on the cartridge mounted to the cartridge mounting portion 200 (step S32), and determines whether the current mode is matched (step S33).

As a result, if the current mode is matched (Yes in step S33), the processing directly returns to the main flow in FIG. 6. On the other hand, when the current mode is not matched (No in step S33), it is determined whether the ink cartridge and the treatment liquid cartridge have been replaced with each other (step S34).

When the ink cartridge and the treatment liquid cartridge are not replaced with each other (No in step S34), the liquid ejection mode is reset according to the type of the mounted cartridge (step S35). The resetting of the liquid ejection mode includes processing of storing, in the nonvolatile memory 83 (see FIG. 3), information on the liquid ejection mode after the change.

When the ink cartridge and the treatment liquid cartridge have been replaced with each other (Yes in step S34), an alert is issued on the operation panel 86, and a user interface for prompting the user to select cartridge replacement or cleaning processing is displayed (step S36). The term “user interface” is hereinafter abbreviated as “UI”.

As an example, the UI may include a message such as “Cartridge replacement requiring cleaning has been detected. Please select whether to perform cartridge replacement after cleaning or perform cartridge replacement without cleaning”.

That is, when the treatment liquid cartridge is mounted to a container where the ink cartridge is mounted, or when the ink cartridge is mounted to a container where the treatment liquid cartridge is mounted, the ink and the treatment liquid may be mixed, and a liquid viscosity may increase, and clogging or the like in the flow path Fr may occur. Accordingly, in this case, the UI including the alert as described above is presented to the user without filling the flow path Fr with a new liquid.

In this case, as a measure taken by the user, cleaning is performed and then cartridge replacement is performed as originally intended, or cartridge replacement without cleaning is performed. Examples of the cartridge replacement without cleaning include replacement between the ink cartridge and the cleaning liquid cartridge and replacement between the treatment liquid cartridge and the cleaning liquid cartridge. It should be noted that, the cartridge replacement without cleaning also includes replacement for returning the cartridge to an original type.

If the user selection (step S37) is cartridge replacement after cleaning, the control unit 80 performs the cleaning processing (step S38) and then displays, on the operation panel 86, a request for replacement of the cartridge originally scheduled for replacement (step S39).

If the user selection (step S37) is cartridge replacement without cleaning, the processing proceeds to step S40.

Regardless of which user selection is made, after replacing the cartridge, the user presses, for example, a “replacement completion button” displayed on the UI of the operation panel 86. In response to this, the control unit 80 acquires the information from the cartridge IC of the cartridge mounted to the cartridge mounting portion 200 (step S40), and if the mounted cartridge is appropriate (Yes in step S41), the processing proceeds to step S35.

If the mounted cartridge is not appropriate (No in step S41), error processing is performed. That the mounted cartridge is appropriate means any of cartridge combinations shown in FIG. 15. In addition, in particular, an example in which the mounted cartridge is not appropriate is a state where the ink cartridge and the treatment liquid cartridge are mounted to the same time.

In step S35, as described above, the liquid ejection mode is reset according to the type of the mounted cartridge.

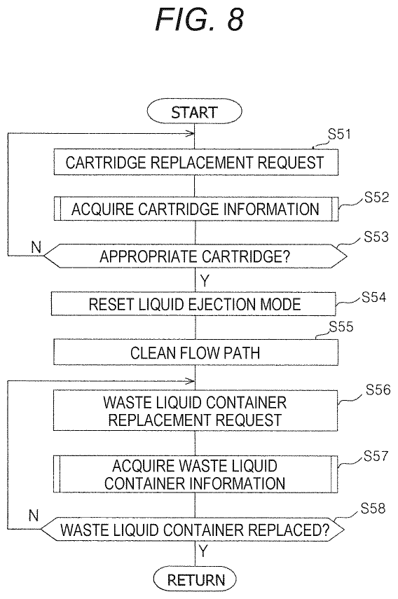

The cleaning processing in step S38 will be described with reference to FIG. 8. In the cleaning processing, the control unit 80 displays, on the operation panel 86, a UI for prompting mounting of the cleaning liquid cartridge (step S51). When the user presses the “replacement completion button” displayed on the UI of the operation panel 86 after mounting the cleaning liquid cartridge, the control unit 80 acquires the information from the cartridge IC of the cartridge mounted to the cartridge mounting portion 200 (step S52). As a result, when the mounted cartridge is appropriate (Yes in step S53), the liquid ejection mode is reset, that is, the liquid ejection mode is set to the cleaning mode (step S54), and the flow path Fr is cleaned (step S55). Here, that the mounted cartridge is appropriate means that the cleaning liquid cartridge is mounted to the cartridge mounting portion 200.

The cleaning of the flow path Fr is processing of operating the pump 18 in addition to processing of ejecting the cleaning liquid from the nozzle 13 to the cap 9a or processing of generating a negative pressure in the cap 9a to suction the cleaning liquid from the nozzle 13. Such processing may directly use the same processing as maintenance for the purpose of preventing clogging of the liquid ejection unit 12 in a state where the ink cartridge is mounted, specifically, a sequence of flushing processing and nozzle suction processing. Alternatively, a sequence for ink initial filling may be directly used. Alternatively, a sequence dedicated to the cleaning liquid may be used. Further, these sequences may be repeated, and accordingly, more reliable cleaning can be performed.

If the mounted cartridge is not appropriate (No in step S53), the processing returns to step S51.

Steps S56, S57, and S58 will be described later again.

The above is the mode setting processing, and step S13 and subsequent steps of the main flow will be described below with reference to FIG. 6.

When the mode setting processing in step S12 ends, the control unit 80 enters a print standby mode (step S13). The print standby mode is a mode for waiting for a user operation.

In response to this, when there is no user operation (“No” in step S14) and a power saving mode transition time is reached (Yes in step S18), the control unit 80 performs power saving mode transition processing (step S19). Accordingly, the liquid ejection apparatus 1 enters a power saving state where power is limitedly supplied only to required portions.

In the state of the power saving mode, when a power saving mode release event occurs such as when the user touches the operation panel 86 and presses a power button (not shown) (Yes in step S20), the processing returns to step S11. When the user issues a print request in the state of the power saving mode, the control unit 80 performs the power-on processing (step S11) and then executes step S15 and subsequent steps to be described later.

Next, when there is a user operation in the state of the print standby mode (“Yes” in step S14), if a content thereof is a power-off operation, the control unit 80 performs power-off processing (step S21), and the processing ends.

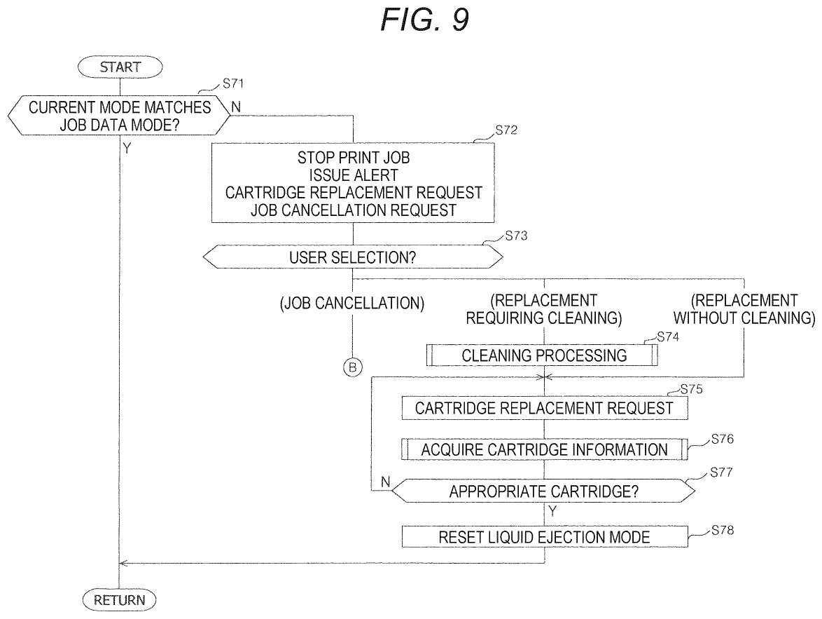

When the content of the user operation is the print request, that is, when the control unit 80 receives print job data, the processing proceeds to step S15, and cartridge determination processing is performed. Hereinafter, the cartridge determination processing will be described with reference to FIG. 9.

First, the control unit 80 determines whether the current liquid ejection mode matches the liquid ejection mode for the print job data (step S71). As a result, if the modes match (Yes in step S71), the processing directly returns to the main flow.

When the current liquid ejection mode does not match the liquid ejection mode for the print job data (No in step S71), the print job is stopped, an alert is issued to the operation panel 86, and a UI for prompting the user to select cartridge replacement or job cancellation is displayed (step S72). As an example, the UI may include a message such as “The mounted cartridge is not compatible. Please select whether to replace the cartridge or stop printing”.

If the user selection (step S73) is job cancellation, the processing returns to step S13 in the main flow.

When the user selection (step S73) is cartridge replacement and is replacement requiring cleaning of the flow path Fr, the processing proceeds to step S74 to perform cleaning processing of the flow path Fr. Such cleaning processing is the same as the processing described with reference to FIG. 8. When the cleaning processing ends, the control unit 80 displays, on the operation panel 86, a request for replacement with a cartridge compatible with the liquid ejection mode for the print job data (step S75).

After replacing the cartridge, the user presses, for example, the “replacement completion button” displayed on the UI of the operation panel 86. In response to this, the control unit 80 acquires information from the cartridge IC of the cartridge mounted to the cartridge mounting portion 200 (step S76), and if the mounted cartridge is compatible with the liquid ejection mode for the print job data (Yes in step S77), the liquid ejection mode is reset (step S78), and the processing returns to the main flow.

If the mounted cartridge is not appropriate (No in step S77), the processing returns to step S75.

When the user selection (step S73) is cartridge replacement and the cartridge replacement does not require cleaning of the flow path Fr, the processing proceeds to step S75 without performing the cleaning processing.

Returning to the main flow in FIG. 6, the control unit 80 executes printing (step S16) and returns to the print standby mode.

Next, when the content of the user operation in step S14 in the main flow in FIG. 6 is the cleaning processing, the processing proceeds to step S17, and the cleaning processing of the flow path Fr is performed. Such cleaning processing is the same as the processing described with reference to FIG. 8.

As described above, when switching from one of the recording mode and the treatment mode to the other, the control unit 80 or the control method implemented by the control unit 80 interposes the cleaning of the flow path Fr by the cleaning mode (step S38 in FIG. 7 and step S74 in FIG. 9).

Accordingly, it is possible to prevent the ink and the treatment liquid from being mixed, and a favorable result is obtained.

The control unit 80 or the control method implemented by the control unit 80 detects the switching from one of the recording mode and the treatment mode to the other based on the received job data (step S71 in FIG. 9), and interposes the cleaning of the flow path Fr by the cleaning mode (step S74 in FIG. 9).

Accordingly, it is possible to cope with a case where the user transmits the job data without being aware of the current mode.

The control unit 80 may detect the mounting of the cartridge to the cartridge mounting portion 200, detect the switching from one of the recording mode and the treatment mode to the other based on such detection, and perform the cleaning of the flow path Fr by the cleaning mode.

For example, in the printing standby mode (step S13 in FIG. 6), the cleaning processing (see FIG. 8) may be implemented when the control unit 80 acquires the cartridge information at predetermined time intervals and the cartridge is replaced corresponding to the switching from one of the recording mode and the treatment mode to the other.

Accordingly, user usability is improved as compared to a case where the user executes the cleaning mode manually.

When it is detected that the cleaning liquid cartridge is mounted, the flow path cleaning (step S55 in FIG. 8) may be executed without checking by the user.

The control unit 80 may also detect the switching from one of the recording mode and the treatment mode to the other based on an input from the operation panel 86 that receives an operation setting from the user, and interpose the cleaning of the flow path Fr by the cleaning mode. The input from the operation panel 86 includes, as an example, printing associated with execution of a copy function, and an instruction to execute a pre-treatment or a post-treatment. Accordingly, user usability is improved as compared to a case where the user executes the cleaning mode manually.

A portion that receives the operation setting from the user is not limited to the operation panel 86 provided in the liquid ejection apparatus 1, and may be an external device coupled to the liquid ejection apparatus 1, for example, a computer.

Each of the ink cartridge, the treatment liquid cartridge, and the cleaning liquid cartridge includes the cartridge IC, which is an information storage unit that holds the liquid information and is an information storage unit accessible by the control unit 80. When the power of the apparatus is turned on, the control unit 80 accesses the cartridge IC (step S32 in FIG. 7), compares with the liquid information at the time of a previous access to the cartridge IC (step S33 in FIG. 7), and issues an alert (step S36 in FIG. 7) when one of the ink cartridge and the treatment liquid cartridge is replaced with the other (Yes in step S34 in FIG. 7).

Accordingly, it is possible to prevent the ink and the treatment liquid from being mixed, and a favorable result is obtained.

In the embodiment, the cleaning mode is a mode in which the flow path Fr is cleaned by performing maintenance using the cleaning liquid and the cap 9a. Accordingly, the flow path Fr can be easily cleaned with favorable workability. At the same time, the cap 9a can also be cleaned.

The liquid ejection apparatus 1 further includes the waste liquid container 17 (see FIG. 4) that stores the waste liquid generated at the cap 9a, and the cleaning liquid used in the cleaning mode is discharged into the waste liquid container 17.

When the cleaning by the cleaning mode is not completed in one of the recording mode and the treatment mode, the control unit 80 restricts the cartridge used in the other mode from being mounted to the cartridge mounting portion 200. This is implemented by, as an example, step S36 in FIG. 7 or the flow from step S72 to step S74 in FIG. 9. Accordingly, it is possible to prevent the ink and the treatment liquid from being mixed.

Here, the restriction does not strictly mean restricting the mounting of the cartridge, but means that an inappropriate cartridge mounting state is prevented from being continued, and the mounting of the cartridge may also be restricted.

A first ink cartridge containing ink of a first color and a second ink cartridge containing ink of a second color different from the first color can be mounted to the cartridge mounting portion 200. Here, in the embodiment, the first color means any one of black, magenta, cyan, and yellow, and the second color means any one of the other colors.

However, the configuration is not limited thereto, and only an ink cartridge of one color, for example, a black ink cartridge may be mountable to the cartridge mounting portion 200.

In addition, only one cartridge may be mountable to the cartridge mounting portion 200.

The cartridge mounting portion 200 has a first mounting region where the first ink cartridge is mounted and a second mounting region where the second ink cartridge is mounted. Here, the first mounting region is at least one of the first mounting portion 211, the second mounting portion 212, the third mounting portion 213, and the fourth mounting portion 214, and the second mounting region is at least one of the other mounting portions. The same applies to the first mounting region and the second mounting region described below.

Here, the control unit 80 may perform the error processing when the treatment liquid cartridge is mounted to one of the first mounting region and the second mounting region and the ink cartridge is mounted to the other. Such error processing is, as an example, error processing branched by No in step S41 in FIG. 7.

Specific processing of the error processing may be as follows. For example, it is assumed that the user selection in step S37 in FIG. 7 is cartridge replacement without cleaning, and the current mode is the treatment mode. When the treatment liquid cartridge is mounted to the first mounting region and the ink cartridge is mounted to the second mounting region, that is, when No is determined in step S41, mounting of the cleaning liquid cartridge or the treatment liquid cartridge to the second mounting region may be prompted by the UI of the operation panel 86.

That is, the control method implemented by the control unit 80 may include determining types of liquid containers mounted to the first mounting region and the second mounting region, and prompting the mounting of the cleaning liquid cartridge or the treatment liquid cartridge to the second mounting region when the current mode is the treatment mode, the treatment liquid cartridge is mounted to the first mounting region, and the ink cartridge is mounted to the second mounting region. However, it is preferable that the mounting of the treatment liquid cartridge to the second mounting region is prompted only when the cleaning of the flow path Fr is completed.

In this way, it is possible to prevent the ink and the treatment liquid from being mixed.

The treatment liquid cartridge and the cleaning liquid cartridge can be mounted to the first mounting region and the second mounting region. In FIG. 5, for example, when the first mounting region is the first mounting portion 211 and the second mounting region is the second mounting portion 212, the treatment liquid cartridge and the cleaning liquid cartridge can be mounted to the first mounting portion 211 and the second mounting portion 212.

Accordingly, a plurality of treatment liquid cartridges can be used. For example, different types of treatment liquids can be mounted to the first mounting portion 211 and the second mounting portion 212, respectively, and can be selectively used. In addition, by simultaneously ejecting the same type of treatment liquid from the first mounting portion 211 and the second mounting portion 212, it is possible to improve throughput when ejecting the treatment liquid to the medium. The pre-treatment mode (high speed) and the post-treatment mode (high speed) in FIG. 5 are examples of modes in which such an effect can be obtained. Specifically, a nozzle where the treatment liquid supplied from the treatment liquid cartridge mounted to the first mounting portion 211 is ejected and a nozzle where the treatment liquid supplied from the treatment liquid cartridge mounted to the second mounting portion 212 is ejected may be disposed such that ejection regions thereof overlap each other. In such a case, by ejecting the treatment liquid from both nozzles, a treatment speed can be increased even at the same ejection interval. Such a tendency is more significant in the case of a serial printing method.

The configuration is not limited to the example in FIG. 5, and different cartridges may be mounted to the cartridge mounting portion 200 as long as liquids do not adversely affect each other even when mixed.

In addition, when cartridges of the same type of liquid are mounted to a plurality of locations, it is possible to reduce a cartridge replacement frequency by preferentially using a cartridge having a large liquid remaining amount.

Regarding the control related to the mounting of the liquid container described above, the following modification can be adopted.

In the embodiment, the liquid ejection unit 12 is a line head. However, the liquid ejection unit 12 as described above may be an ink ejection head that is mounted to a carriage and ejects the liquid while moving in the medium width direction. In this case, the cartridge mounting portion 200 may be provided at the carriage or may be fixedly provided outside the carriage.

The liquid container is a cartridge in the embodiment, but is not limited thereto. For example, a liquid-containing pack that contains the liquid may be used. Alternatively, the container may be configured as a liquid tank, and the liquid tank may be of a type that allows the liquid to be refilled.

When the flow path Fr is cleaned, in the above embodiment, the cleaning liquid cartridge is mounted to each container of the cartridge mounting portion 200, alternatively, for example, an adapter (not shown) including the liquid supply unit 310 (see FIG. 4) may be mounted to the container, and the cleaning liquid may be supplied to the adapter from the cleaning liquid container that contains the cleaning liquid via an ink tube.

As a usage aspect when one liquid ejection apparatus 1 is used, an aspect is conceivable in which the pre-treatment is performed on the medium by the pre-treatment mode, then the ink cartridge is mounted via the cleaning processing, and recording is performed on the medium. In this case, as a method for applying the pre-treatment liquid, the pre-treatment liquid may be applied to the entire surface of the medium, or the pre-treatment liquid may be applied only to a region where recording is performed. When the pre-treatment liquid is applied only to the region where recording is performed, a size of the region where the pre-treatment liquid is applied and a size of the region where recording is performed may match, or the pre-treatment liquid may be applied to a region slightly larger than the region where recording is performed. In the case of the treatment mode, the user may be allowed to set in advance whether the application to the entire surface or the application limited to the recording region is to be executed.

When the pre-treatment is performed on the medium by the pre-treatment mode, ejection accuracy may be lower than that in a case where recording is performed using the ink, and accordingly, when the pre-treatment is performed on the medium by the pre-treatment mode, it is also preferable to set a medium conveyance speed to be higher than that in a case where recording is performed using the ink.

The job data may not include information on the liquid ejection mode. For example, the liquid ejection mode may be set in the liquid ejection apparatus 1, and the liquid ejection apparatus 1 may print image data in the job data based on the set liquid ejection mode. In this case, the cartridge determination processing S15 may not be executed.

### Control Related to Discharge of Waste Liquid to Waste Liquid Container

Next, control related to discharge of the waste liquid into the waste liquid container 17 will be described.

In the embodiment, the control unit 80 or the control method implemented by the control unit 80 does not discharge the treatment liquid into the waste liquid container 17 when the ink is contained in the waste liquid container 17, and does not discharge the ink into the waste liquid container 17 when the treatment liquid is contained in the waste liquid container 17. Accordingly, it is possible to prevent the ink and the treatment liquid from being mixed in the waste liquid container 17.

Such control by the control unit 80 will be described with reference to steps S56 to S58 in FIG. 8. After cleaning the flow path Fr (step S55), the control unit 80 displays, on the operation panel 86, a replacement request for the waste liquid container 17 (step S56).

At this time, the UI of the operation panel 86 may include a message such as “Please replace the waste liquid container with a new one.” as an example.

That is, according to the flow in FIG. 8, the waste liquid container 17 before replacement contains the ink and the cleaning liquid, or contains the treatment liquid and the cleaning liquid. The cleaning of the flow path Fr is switching from the ink mode to the treatment mode or switching from the treatment mode to the ink mode, and thus the ink and the treatment liquid are mixed inside the waste liquid container 17 unless the waste liquid container 17 is replaced.

Accordingly, the control unit 80 prompts the user to replace the waste liquid container 17 after cleaning the flow path Fr (step S55).

After replacing the waste liquid container 17, the user presses, for example, the “replacement completion button” displayed on the UI of the operation panel 86. In response to this, the control unit 80 acquires the information from the waste liquid container IC 230 (step S57), and when the mounted waste liquid container 17 is new (Yes in step S58), the processing is ended.

The cleaning processing shown in FIG. 8 is the content of step S38 shown in FIG. 7 or step S74 shown in FIG. 9, that is, the control unit 80 prompts replacement of the waste liquid container 17 before switching from one of the recording mode and the treatment mode to the other. Accordingly, it is possible to more reliably prevent the ink and the treatment liquid from being mixed in the waste liquid container 17.

The control unit 80 switches to the cleaning mode before switching from one mode of the recording mode and the treatment mode to the other mode, and switches from the one mode to the other mode when the waste liquid container 17 is replaced after the cleaning of the flow path Fr is completed. Accordingly, it is possible to prevent the ink and the treatment liquid from being mixed in the flow path Fr.

The control unit 80 can store the type of waste liquid discharged into the waste liquid container 17 mounted to the mounting portion 16 in the waste liquid container IC 230, which is an example of a storage medium, or the nonvolatile memory 83. Accordingly, it is possible to more reliably prevent the ink and the treatment liquid from being mixed in the waste liquid container 17.

In addition, since the type of the waste liquid contained in the waste liquid container 17 can be stored, the waste liquid container 17 can be used by being attached again after being detached from the mounting portion 16 while preventing the ink and the treatment liquid from being mixed.

In the above-described example, the replacement of the mounted waste liquid container 17 is prompted after the end of the cleaning processing (steps S56 to S58), and alternatively, the replacement of the waste liquid container 17 may be prompted before the cleaning processing. That is, steps S56 to S58 may be executed before step S55.

However, when the waste liquid container 17 is not of a type that is repeatedly attached and detached for use and the waste liquid container 17 before replacement is not full, it is preferable to discharge the waste liquid into the waste liquid container 17 before replacement such that a capacity of the waste liquid container 17 can be effectively used.

The information on the waste liquid container 17 may be acquired each time the waste liquid is discharged, specifically, each time the pump 18 is driven, and it may be determined whether the waste liquid to be discharged is compatible with the currently mounted waste liquid container 17 each time.

In the above-described example, the information on the waste liquid container 17 is acquired from the waste liquid container IC 230 (step S57), and it is determined whether the waste liquid container 17 has been replaced based on a result thereof (step S58), and instead of step S57, the determination may be performed based on opening and closing of an opening and closing cover (not shown) for attaching and detaching the waste liquid container 17. That is, when it is detected that the opening and closing cover is opened and closed, it may be determined that the waste liquid container 17 has been replaced. In this case, the waste liquid container IC 230 may not be necessarily provided. Alternatively, instead of step S57, a message “Has the waste liquid container been replaced?” may be displayed on the UI of the operation panel 86, and when the user presses “Yes” in response to this, it may be determined that the waste liquid container 17 has been replaced. In this case, the waste liquid container IC 230 may also not be necessarily provided.

In addition, in the above-described example, the control unit 80 performs control to avoid mixing of the ink and the treatment liquid, and alternatively, control may be performed to mix the ink and the treatment liquid via the cleaning liquid as long as a reaction such as hardening can be avoided by mixing the ink and the treatment liquid via the cleaning liquid. In addition, if a reaction such as hardening occurs due to mixing of different types of treatment liquids, the control unit 80 may perform control to avoid mixing of different types of treatment liquids.

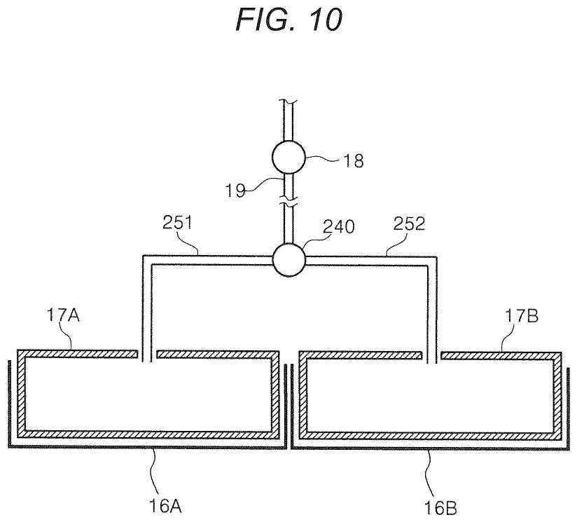

Next, an example using a plurality of waste liquid containers will be described with reference to FIG. 10. In the configuration shown in FIG. 10, a first mounting portion 16A includes a first waste liquid container 17A, and a second mounting portion 16B includes a second waste liquid container 17B. Reference sign 240 denotes a switching unit that switches a flow destination of the waste liquid, the switching unit 240 and the first waste liquid container 17A are coupled by a tube 251, and the switching unit 240 and the second waste liquid container 17B are coupled by a tube 252. The tube 251 forms a first waste liquid flow path through which the waste liquid flows to the first waste liquid container 17A, and the tube 252 forms a second waste liquid flow path through which the waste liquid flows to the second waste liquid container 17B.

The tube 19 forms a common waste liquid flow path through which the waste liquid flows from the cap 9a to the first waste liquid flow path and the second waste liquid flow path.

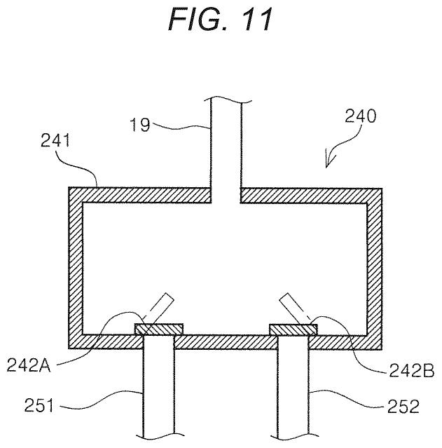

As the switching unit 240, a known valve can be adopted, and as an example, as shown in FIG. 11, valves 242A and 242B are provided in a case 241. These valves can be configured with, for example, solenoid valves. For each valve, a solid line indicates a closed state and a two-dot chain line indicates an open state.

When the valve 242A is opened and the valve 242B is closed, the flow destination of the waste liquid becomes the first waste liquid container 17A. When the valve 242A is closed and the valve 242B is opened, the flow destination of the waste liquid becomes the second waste liquid container 17B.

The switching unit 240 can be controlled by the control unit 80. The control unit 80 or the control method implemented by the control unit 80 does not discharge the treatment liquid to the first waste liquid container 17A when the ink is contained in the first waste liquid container 17A, and does not discharge the ink to the first waste liquid container 17A when the treatment liquid is contained in the first waste liquid container 17A. Similarly, the control unit 80 does not discharge the treatment liquid to the second waste liquid container 17B when the ink is contained in the second waste liquid container 17B, and does not discharge the ink to the second waste liquid container 17B when the treatment liquid is contained in the second waste liquid container 17B.

Accordingly, it is possible to prevent the ink and the treatment liquid from being mixed in both the first waste liquid container 17A and the second waste liquid container 17B.

When the discharge destination is switched, it is preferable to discharge the liquid inside the switching unit 240, empty the inside of the switching unit 240, and then introduce the liquid to be discharged next into the switching unit 240. Accordingly, it is possible to prevent different liquids from being mixed inside the switching unit 240.

Next, in such a configuration, the control unit 80 or the control method implemented by the control unit 80 may discharge the ink to the first waste liquid container 17A and discharge the treatment liquid to the second waste liquid container 17B. By discharging different liquids in the first waste liquid container 17A and the second waste liquid container 17B in this way, it is possible to discharge the ink and the treatment liquid without requiring the user to perform a special replacement operation. The control unit 80 may discharge the treatment liquid to the first waste liquid container 17A and discharge the ink to the second waste liquid container 17B.

In this case, the control unit 80 may discharge the ink to the first waste liquid container 17A when the ink is contained in the first waste liquid container 17A or the waste liquid is not contained in the first waste liquid container 17A, and may discharge the treatment liquid to the second waste liquid container 17B when the treatment liquid is contained in the second waste liquid container 17B or the waste liquid is not contained in the second waste liquid container 17B. In this way, use of each waste liquid container can be set.

Next, the liquid ejection unit 12 can eject the first treatment liquid and the second treatment liquid as the treatment liquid. The first treatment liquid and the second treatment liquid are liquids having reactivity such as hardening when mixed, and for example, one is the pre-treatment liquid and the other is the post-treatment liquid.

When the ink is contained in the first waste liquid container 17A and the first treatment liquid is contained in the second waste liquid container 17B, the control unit 80 may prompt replacement of the first waste liquid container 17A or the second waste liquid container 17B without discharging the second treatment liquid to any of the first waste liquid container 17A and the second waste liquid container 17B.

In addition, when the first treatment liquid is contained in the first waste liquid container 17A and the second treatment liquid is contained in the second waste liquid container 17B, the control unit 80 may prompt the replacement of the first waste liquid container 17A or the second waste liquid container 17B without discharging the ink to any of the first waste liquid container 17A and the second waste liquid container 17B.

Accordingly, it is possible to prevent a plurality of types of waste liquid from being mixed in the first waste liquid container 17A or the second waste liquid container 17B.

Next, in a configuration in which a plurality of waste liquid containers can be mounted, the control unit 80 may switch the switching unit 240 before switching from one of the recording mode and the treatment mode to the other. In this way, since the control unit 80 switches the switching unit when the mode is switched, it is possible to prevent a plurality of types of the waste liquid from being mixed in the first waste liquid container 17A or the second waste liquid container 17B.

In a configuration in which a plurality of waste liquid containers are provided, the control unit 80 may grasp an amount of the waste liquid contained in the first waste liquid container 17A and an amount of the waste liquid contained in the second waste liquid container 17B, and discharge the cleaning liquid into the waste liquid container where the amount of the contained waste liquid is small between the first waste liquid container 17A and the second waste liquid container 17B. Accordingly, the replacement frequency of the waste liquid container can be reduced.

The control unit 80 may discharge the cleaning liquid into the waste liquid container suitable for the current liquid ejection mode, and in this case, the number of times of switching of the switching unit 240 can be reduced.

In addition, when an absorbent material that absorbs the waste liquid is provided inside the waste liquid container, the cleaning liquid may be preferentially discharged to a side where the waste liquid easily clogs in the absorbent material. In addition, the cleaning liquid may be discharged to a side where the waste liquid that is prone to evaporation is contained.

In the configuration in which a plurality of waste liquid containers can be mounted, the control unit 80 or the control method implemented by the control unit 80 may discharge the waste liquid of the same type to the first waste liquid container 17A and the second waste liquid container 17B. Accordingly, it is possible to reduce the replacement frequency of the waste liquid container when the waste liquid of the same type is discharged. In this case, one of the first waste liquid container 17A and the second waste liquid container 17B may be used first, and when the container becomes full, the other may be used, or the waste liquid may be uniformly discharged to both of the containers.

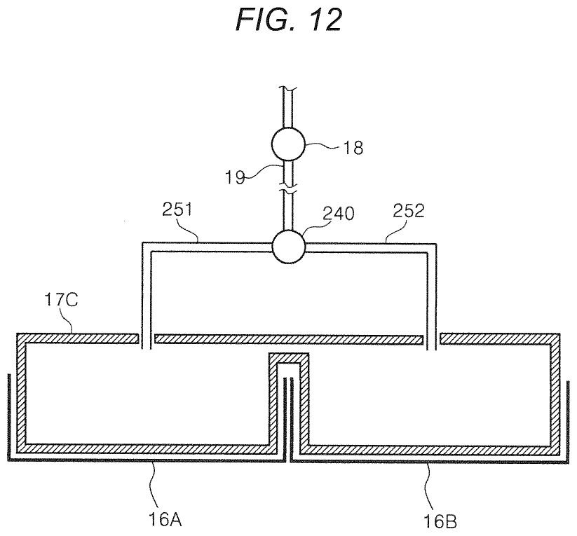

As shown in FIG. 12, a large-capacity waste liquid container 17C that can be mounted using spaces of both the first mounting portion 16A and the second mounting portion 16B may be mountable to the first mounting portion 16A and the second mounting portion 16B. In this case, the control unit 80 or the control method implemented by the control unit 80 discharges the waste liquid of the same type to the large-capacity waste liquid container 17C. According to such a configuration, the replacement frequency of the waste liquid container can be reduced. A space inside the large-capacity waste liquid container 17C may be partitioned by a wall.

### Other Embodiments of Flow Path

Next, other embodiments of the flow path will be described.

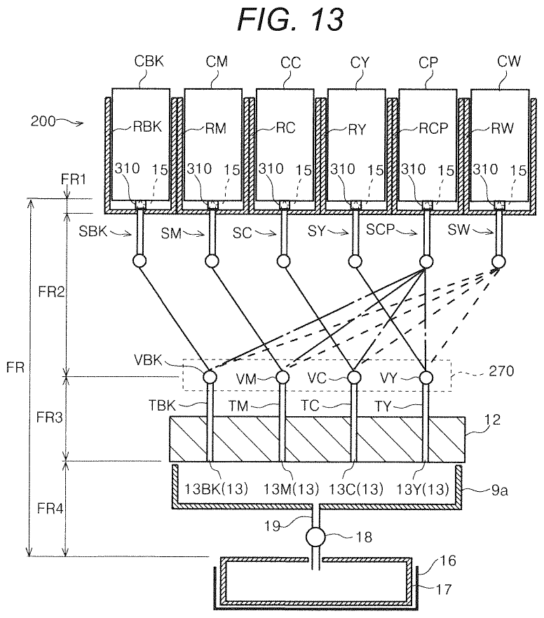

The above-described flow path may be formed as shown in FIG. 13. A flow path FR includes a flow path FR1, a flow path FR2, a flow path FR3, and a flow path FR4. The flow path FR1 is a section in the cartridge mounting portion 200. The flow path FR2 is a section between the cartridge mounting portion 200 and a switching unit 270 to be described later. The flow path FR3 is a section between the switching unit 270 and the nozzle 13. The flow path FR4 is a section from the cap 9a into the waste liquid container 17. The flow path FR4 is an example of the waste liquid flow path.

The flow path FR can be cleaned by discharging the cleaning liquid from the nozzle 13 and operating the pump 18 in a state where the cleaning liquid cartridge is mounted to the cartridge mounting portion 200. Hereinafter, the simple phrase “cleaning of the flow path” or “cleaning processing” means cleaning of the flow path FR.

The cartridge mounting portion 200 according to the embodiment includes a plurality of containers for containing the cartridges. Specifically, the cartridge mounting portion 200 includes a black container RBK, a magenta container RM, a cyan container RC, a yellow container RY, a treatment liquid container RCP, and a cleaning liquid container RW.

That is, a plurality of cartridges are attachable to and detachable from the cartridge mounting portion 200 according to the embodiment.

The flow path FR includes a plurality of supply flow paths through which the liquid flows from each container to the liquid ejection unit 12, and a common flow path which is coupled to at least one of the plurality of supply flow paths and through which the liquid flows to the liquid ejection unit 12.

In the embodiment, the flow path FR2 includes a plurality of supply flow paths, and the flow path FR3 includes a plurality of common flow paths. Each flow path is formed of a tube as an example. In FIG. 13, in order to avoid complication of illustration, a part of tubes is drawn in a simplified manner using solid lines, one-dot chain lines, and broken lines.

The flow path FR2 include the plurality of supply flow paths, that is, a black supply flow path SBK, a magenta supply flow path SM, a cyan supply flow path SC, a yellow supply flow path SY, a treatment liquid supply flow path SCP, and a cleaning liquid supply flow path SW. Each supply flow path is a flow path from each container to the switching unit 270.

The black supply flow path SBK is coupled to a black flow path selection unit VBK to be described later. The magenta supply flow path SM is coupled to a magenta flow path selection unit VM to be described later. The cyan supply flow path SC is coupled to a cyan flow path selection unit VC to be described later. The yellow supply flow path SY is coupled to a yellow flow path selection unit VY to be described later.

Meanwhile, the treatment liquid supply flow path SCP and the cleaning liquid supply flow path SW are coupled to all the flow path selection units. That is, the treatment liquid supply flow path SCP branches into four flow paths, and a section from a branch portion to each flow path selection unit is indicated by a one-dot chain line. In addition, the cleaning liquid supply flow path SW branches into four flow paths, and a section from a branch portion to each flow path selection unit is indicated by broken lines.

The nozzles 13 provided in the liquid ejection unit 12 include a black nozzle 13BK corresponding to black ink, a magenta nozzle 13M corresponding to magenta ink, a cyan nozzle 13C corresponding to cyan ink, and a yellow nozzle 13Y corresponding to yellow ink.

The flow path FR3, that is, the plurality of common flow paths include a black common flow path TBK, a magenta common flow path TM, a cyan common flow path TC, and a yellow common flow path TY.

A flow path selection unit is provided for each common flow path. The black flow path selection unit VBK is provided for the black common flow path TBK. The magenta flow path selection unit VM is provided for the magenta common flow path TM. The cyan flow path selection unit VC is provided for the cyan common flow path TC. The yellow flow path selection unit VY is provided for the yellow common flow path TY. Each flow path selection unit constitutes the switching unit 270.

A supply flow path of a corresponding color is coupled to each flow path selection unit, and the treatment liquid supply flow path SCP and the cleaning liquid supply flow path SW are further coupled thereto. That is, in the embodiment, three supply flow paths are coupled to one flow path selection unit.

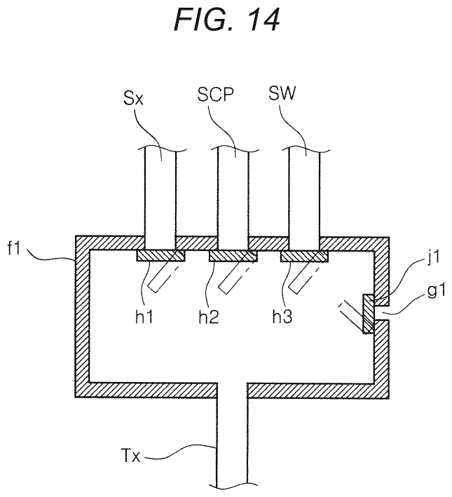

The flow path selection units have the same structure, known valves can be adopted, and as an example, as shown in FIG. 14, valves h1, h2, and h3 are provided in a case f1. The valves h1, h2, and h3 are examples of first, second, and third switching valves, respectively. These valves can be configured with, for example, solenoid valves. For each valve, a solid line indicates a closed state and a two-dot chain line indicates an open state. A valve j1 is a valve that opens and closes an atmospheric communication hole g1.

Reference sign Sx denotes any one of the supply flow paths (SBK, SM, SC, and SY) described above. Reference sign Tx denotes any one of the common flow paths (TBK, TM, TC, and TY) described above.

When the valve h1 is opened and the other valves are closed, the supply flow path Sx is coupled to the common flow path Tx. When the valve h2 is opened and the other valves are closed, the treatment liquid supply flow path SCP is coupled to the common flow path Tx. When the valve h3 is opened and the other valves are closed, the cleaning liquid supply flow path SW is coupled to the common flow path Tx.

The opening and closing of each valve described above are performed by the control unit 80.

With the configuration described above, as shown in FIG. 15, a liquid ejection mode similar to that in FIG. 5 can be set according to a selection state of each flow path selection unit. The liquid ejection mode differs depending on the selected supply flow path.

In the embodiment, the black flow path selection unit VBK can select any one of the black supply flow path SBK, the treatment liquid supply flow path SCP, and the cleaning liquid supply flow path SW and couple the selected flow path to the black common flow path TBK. The magenta flow path selection unit VM can select any one of the magenta supply flow path SM, the treatment liquid supply flow path SCP, and the cleaning liquid supply flow path SW and couple the selected flow path to the magenta common flow path TM. The cyan flow path selection unit VC can select any one of the cyan supply flow path SC, the treatment liquid supply flow path SCP, and the cleaning liquid supply flow path SW and couple the selected flow path to the cyan common flow path TC. The yellow flow path selection unit VY can select any one of the yellow supply flow path SY, the treatment liquid supply flow path SCP, and the cleaning liquid supply flow path SW and couple the selected flow path to the yellow common flow path TY.

These notations of SBK, SM, SC, SY, SCP, and SW shown in parentheses in FIG. 15 indicate the supply flow paths described above.

It is not always required to mount the cartridges at all the mounting portions of the cartridge mounting portion 200, provided that the cartridges required for the liquid ejection mode are mounted. For example, when the ink mode (all colors) is performed, a treatment liquid cartridge CP and a cleaning liquid cartridge CW may not necessarily be mounted. In addition, an ink cartridge C may be mountable to one or both of the treatment liquid container RCP and the cleaning liquid container RW. Accordingly, a capacity of one or two of ink cartridges C of four colors can be increased.

In the example in FIG. 15, in the case of the ink mode (single color), the flow path selection units other than the black flow path selection unit VBK select the cleaning liquid supply flow path SW, and alternatively, no supply flow path may be selected, that is, all of the valves h1, h2, h3, and j1 shown in FIG. 14 may be closed. Similarly, in the case of the treatment mode, the flow path selection units other than the black flow path selection unit VBK select the cleaning liquid supply flow path SW, and alternatively, no supply flow path may be selected.

In addition, the cleaning liquid cartridge CW may be mountable to both the treatment liquid container RCP and the cleaning liquid container RW, or the treatment liquid cartridge CP may be mountable. In this way, a capacity of the cleaning liquid cartridge CW or the treatment liquid cartridge CP can be increased.

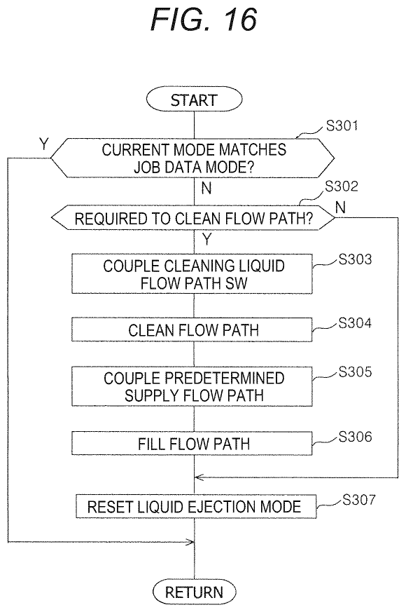

In such a configuration, it is preferable to adopt mode determination processing shown in FIG. 16 instead of the cartridge determination processing (step S15) in FIG. 6.

In FIG. 16, the control unit 80 determines whether the current liquid ejection mode matches the liquid ejection mode for the print job data (step S301). As a result, if the modes match (Yes in step S301), the processing returns to the main flow directly.

When the current liquid ejection mode does not match the liquid ejection mode for the print job data (No in step S301), the control unit 80 determines whether flow path cleaning is required (step S302).

Here, a case where the flow path cleaning is required (Yes in step S302) is a case where the ink and the treatment liquid are mixed in the flow path, for example, a case where the mode is switched between the ink mode (single color) or the ink mode (all colors) in FIG. 15 and the treatment mode or the treatment mode (high speed).

In this case, since it is required to clean the flow path, the control unit 80 selects the cleaning liquid supply flow path SW in each flow path selection unit, and couples the cleaning liquid supply flow path SW to each common flow path (step S303). When there is a flow path that does not require cleaning, all the valves (the valves h1, h2, h3, and j1 in FIG. 14) of the flow path selection unit may be closed. For example, when switching from the ink mode (single color) to the treatment mode in FIG. 15, it is not required to clean the flow path selection units of the magenta flow path selection unit VM, the cyan flow path selection unit VC, and the yellow flow path selection unit VY, and downstream common flow paths thereof. Accordingly, all the valves of such flow path selection units may be closed.

Next, the control unit 80 performs flow path cleaning (step S304). The flow path cleaning includes filling the flow path with the cleaning liquid, discharging the cleaning liquid to the cap 9a, and collecting the cleaning liquid discharged to the cap 9a. The flow path is filled with the liquid (in this case, the cleaning liquid) by operating the pump 18 in a state where the liquid ejection unit 12 is capped by the cap 9a. The cleaning liquid discharged to the cap 9a is collected by operating the pump 18. Regarding the discharge of the waste liquid into the waste liquid container 17, the control unit 80 does not discharge the treatment liquid into the waste liquid container 17 when the ink is contained in the waste liquid container 17 as described above, and does not discharge the ink into the waste liquid container 17 when the treatment liquid is contained in the waste liquid container 17. Accordingly, it is possible to prevent the ink and the treatment liquid from being mixed in the waste liquid container 17.

The filling of the flow path with the liquid and the ejection of the liquid to the cap 9a may directly use the same processing as the maintenance for the purpose of preventing clogging of the liquid ejection unit 12, specifically, the sequence of the flushing process and the nozzle suction processing. Alternatively, the sequence for ink initial filling may be directly used. Alternatively, a dedicated sequence may be used. Further, these sequences may be repeated, and accordingly, more reliable cleaning can be performed.

When the flow path cleaning ends, the control unit 80 selects a predetermined supply flow path in each flow path selection unit (step S305) and fills the flow path (step S306). For example, when the mode is switched to the ink mode (single color) in FIG. 6 after the cleaning ends, the black supply flow path SBK is selected in the black flow path selection unit VBK in step S305. The flow path filling in step S306 is performed by operating the pump 18 in the state where the liquid ejection unit 12 is capped by the cap 9a as described above.

Then, the control unit 80 resets the liquid ejection mode (step S307). The control unit 80 stores the set liquid ejection mode in the nonvolatile memory 83 (see FIG. 3).

The present disclosure is not limited to the embodiment and the modification described above and various modifications can be made within the scope of the disclosure set forth in the appended claims, and it should be noted that these modifications also fall within the scope of the present disclosure.

What is claimed is:

1. A liquid ejection apparatus comprising:
a liquid ejection unit configured to eject a liquid onto a medium;
a collection unit configured to collect, as a waste liquid, the liquid ejected from the liquid ejection unit;
a mounting portion where a waste liquid container configured to contain the waste liquid collected by the collection unit is attachable and detachable;
a waste liquid flow path configured to allow the waste liquid to flow into the waste liquid container; and
a control unit configured to control the delivery of the waste liquid into the waste liquid container, wherein
the liquid ejection unit is configured to eject
a recording liquid for recording on the medium,
a treatment liquid that is a liquid having reactivity with the recording liquid and performs a treatment on the medium, and
a cleaning liquid for cleaning the liquid ejection unit, and
the control unit
does not discharge the treatment liquid into the waste liquid container when the recording liquid is contained in the waste liquid container, and
does not discharge the recording liquid into the waste liquid container when the treatment liquid is contained in the waste liquid container.

2. The liquid ejection apparatus according to claim 1, wherein
the control unit is switchable between
a recording mode when recording is performed on the medium by the recording liquid,
a treatment mode when a treatment is performed on the medium by the treatment liquid, and
a cleaning mode when the waste liquid flow path is cleaned by the cleaning liquid, and
the control unit further prompts replacement of the waste liquid container before switching from one of the recording mode and the treatment mode to the other.

3. The liquid ejection apparatus according to claim 2, wherein
the control unit
switches to the cleaning mode before switching from one mode of the recording mode and the treatment mode to the other mode, and
switches from the one mode to the other mode when the waste liquid container is replaced after the cleaning of the waste liquid flow path is completed.

4. The liquid ejection apparatus according to claim 1, wherein
the control unit is configured to store, in a storage medium, the type of the waste liquid discharged into the waste liquid container mounted to the mounting portion.

5. The liquid ejection apparatus according to claim 1, wherein
the waste liquid container is a first waste liquid container, the mounting portion is a first mounting portion, and the waste liquid flow path is a first waste liquid flow path,
the liquid ejection apparatus further comprises:
a second mounting portion where a second waste liquid container configured to contain the waste liquid collected by the collection unit is attachable and detachable;
a second waste liquid flow path configured to allow the waste liquid to flow to the second waste liquid container;
a common waste liquid flow path configured to allow the waste liquid to flow from the collection unit to the first waste liquid flow path and the second waste liquid flow path; and
a switching unit configured to switch a flow destination of the waste liquid from the common waste liquid flow path to one of the first waste liquid flow path and the second waste liquid flow path, and
the control unit
does not discharge the treatment liquid to the second waste liquid container when the recording liquid is contained in the second waste liquid container, and
does not discharge the recording liquid to the second waste liquid container when the treatment liquid is contained in the second waste liquid container.

6. The liquid ejection apparatus according to claim 5, wherein
the control unit discharges the recording liquid to the first waste liquid container and discharges the treatment liquid to the second waste liquid container.

7. The liquid ejection apparatus according to claim 6, wherein
the control unit
discharges the recording liquid to the first waste liquid container when the recording liquid is contained in the first waste liquid container or when the waste liquid is not contained in the first waste liquid container, and
discharges the treatment liquid to the second waste liquid container when the treatment liquid is contained in the second waste liquid container or when the waste liquid is not contained in the second waste liquid container.

8. The liquid ejection apparatus according to claim 5, wherein
the liquid ejection unit is configured to eject the treatment liquid as a first treatment liquid and is further configured to eject a second treatment liquid that is a liquid having reactivity with the recording liquid and the treatment liquid and performs a treatment on the medium, and
the control unit
does not discharge the second treatment liquid to either the first waste liquid container or the second waste liquid container and prompts replacement of the first waste liquid container or the second waste liquid container, when the recording liquid is contained in the first waste liquid container and the first treatment liquid is contained in the second waste liquid container, and
does not discharge the recording liquid to either the first waste liquid container or the second waste liquid container and prompts the replacement of the first waste liquid container or the second waste liquid container when the first treatment liquid is contained in the first waste liquid container and the second treatment liquid is contained in the second waste liquid container.

9. The liquid ejection apparatus according to claim 5, wherein
the control unit is switchable between
a recording mode when recording is performed on the medium by the recording liquid,
a treatment mode when a treatment is performed on the medium by the treatment liquid, and
a cleaning mode when the first waste liquid flow path or the second waste liquid flow path is cleaned by the cleaning liquid, and
the control unit further switches the switching unit before switching from one of the recording mode and the treatment mode to the other.

10. The liquid ejection apparatus according to claim 5, wherein
the control unit is configured to grasp
an amount of the waste liquid contained in the first waste liquid container, and
an amount of the waste liquid contained in the second waste liquid container, and
the control unit further discharges the cleaning liquid to a waste liquid container where the amount of the contained waste liquid is smaller among the first waste liquid container and the second waste liquid container.

11. The liquid ejection apparatus according to claim 5, wherein
the control unit discharges the waste liquid of a same type to the first waste liquid container and the second waste liquid container.

12. The liquid ejection apparatus according to claim 5, wherein
a large-capacity waste liquid container mountable using spaces of both the first mounting portion and the second mounting portion is mountable to the first mounting portion and the second mounting portion, and
the control unit discharges the waste liquid of a same type to the large-capacity waste liquid container.

13. A control method for a liquid ejection apparatus,
the liquid ejection apparatus including,
a liquid ejection unit configured to eject a liquid onto a medium,
a collection unit configured to collect, as a waste liquid, the liquid ejected from the liquid ejection unit,
a mounting portion where a waste liquid container configured to contain the waste liquid collected by the collection unit is attachable and detachable,
a waste liquid flow path configured to allow the waste liquid to flow into the waste liquid container, and
a control unit configured to control the delivery of the waste liquid into the waste liquid container,
the liquid ejection unit is configured to eject
a recording liquid for recording on the medium,
a treatment liquid that is a liquid having reactivity with the recording liquid and performs a treatment on the medium, and
a cleaning liquid for cleaning the liquid ejection unit, and
the control method comprising:
preventing the treatment liquid from being discharged into the waste liquid container when the recording liquid is contained in the waste liquid container; and
preventing the recording liquid from being discharged into the waste liquid container when the treatment liquid is contained in the waste liquid container.

14. The control method for a liquid ejection apparatus according to claim 13, wherein
the waste liquid container is a first waste liquid container, the mounting portion is a first mounting portion, and the waste liquid flow path is a first waste liquid flow path,
the liquid ejection apparatus includes
a second mounting portion where a second waste liquid container configured to contain the waste liquid collected by the collection unit is attachable and detachable,
a second waste liquid flow path configured to allow the waste liquid to flow to the second waste liquid container,
a common waste liquid flow path configured to allow the waste liquid to flow from the collection unit to the first waste liquid flow path and the second waste liquid flow path, and
a switching unit configured to switch a flow destination of the waste liquid from the common waste liquid flow path to one of the first waste liquid flow path and the second waste liquid flow path, and
the control method further comprises:
preventing the treatment liquid from being discharged to the second waste liquid container when the recording liquid is contained in the second waste liquid container; and
preventing the recording liquid from being discharged to the second waste liquid container when the treatment liquid is contained in the second waste liquid container.

15. The control method for a liquid ejection apparatus according to claim 14, wherein
the waste liquid of a same type is discharged to the first waste liquid container and the second waste liquid container.
